(19) United States
(12) Patent Application Publication
(10) Pub. No.: US 2026/0004379 A1
(43) Pub. Date: Jan. 1, 2026

(54) VISUAL MASKS FOR DIGITAL WATERMARKING OF DIGITAL IMAGERY

(71) Applicant: Digimarc Corporation, Beaverton, OR (US)

(72) Inventors: Aparna Gurijala, Port Coquitlam (CA); Tomas Filler, Beaverton, OR (US); Dimitrios Chachlakis, Rochester, NY (US); Manish Sharma, Portland, OR (US); Sriram Baireddy, Canonsburg, PA (US); Jerry McMahan, Oakwood, OH (US)

(21) Appl. No.: 19/251,468

(22) Filed: Jun. 26, 2025

Related U.S. Application Data
(60) Provisional application No. 63/666,094, filed on Jun. 28, 2024.

(51) Int. Cl. G06T 1/00

(52) U.S. Cl. CPC G06T 1/0028; G06T 2201/0202

(57) ABSTRACT

The present disclosure relates to digital watermarking systems that may use visual masks to optimize watermark embedding in digital imagery. A visual mask provides guidance for adjusting digital watermark signal strength, enabling improved trade-offs between watermark imperceptibility and robustness. Multiple embodiments generate visual masks including: (1) a Perceptual Modeling Candidate approach using contrast masking and texture classification based on standard deviation mapping; (2) a wavelet-based approach using Dual-Tree Complex Wavelet Transform for translation-invariant frequency analysis; (3) artificial intelligence approaches employing convolutional neural networks trained to optimize embedding strength while minimizing perceptual distance metrics such as LPIPS; and (4) LPIPS threshold masking that determines optimal embedding strengths by testing multiple candidate strengths. Visual masks enable content-adaptive digital watermarking that places stronger signals in textured regions while maintaining imperceptibility in flat regions, improving visibility-robustness performance compared to uniform embedding approaches.

### RELATED APPLICATION DATA

This application claims the benefit of U.S. Provisional Application No. 63/666,094, filed Jun. 28, 2024, which is hereby incorporated herein by reference in its entirety.

### TECHNICAL FIELD

The disclosed technology relates to complex image signal processing including digital watermarking, image perceptual modeling and artificial intelligence.

### BACKGROUND AND SUMMARY

For purposes of this disclosure, the terms “digital watermark,” “watermark” and “data hiding” are used interchangeably. (In contrast, the term “visual watermark” means an overt mark or logo superimposed onto an image, video, or other media.) We sometimes use the terms “embedding,” “embed,” “encoding,” “encode” and data hiding” to interchangeably mean modulating or transforming data representing digital asset to include information therein. For example, data hiding may seek to hide or embed an information signal (e.g., a plural bit payload or a modified version of such, e.g., a 2-D error corrected, spread spectrum signal) in a host signal. This can be accomplished, e.g., by modulating a host signal (e.g., representing digital content) in some fashion to carry the information signal. We sometimes use the terms “encoder” and “embedder” to interchangeably mean software, circuitry, an apparatus and/or module to modulate or transform data representing digital content to include information therein. Similarly, we sometimes use the terms “decode,” “detect” and “read” (and various forms thereof) to interchangeably mean analyzing content to obtain a payload or signal element embedded or encoded therein. Similarly, we sometimes use the terms “decoder,” “detector” and “reader” to interchangeably mean software, circuitry, apparatus and/or module to analyze content to obtain a payload or signal element embedded or encoded therein.

Digimarc Corporation headquartered in Beaverton, Oregon, USA, is a leader in the field of digital watermarking. Some of Digimarc's work in data hiding and digital watermarking is reflected, e.g., in U.S. Pat. Nos. 11,410,262; 11,410,261; 11,233,918; 11,188,996; 11,188,996; 11,062,108; 10,652,422; 10,453,163; 10,282,801; 6,947,571; 6,912,295; 6,891,959; 6,763,123; 6,718,046; 6,614,914; 6,590,996; 6,408,082; 6,122,403 and 5,862,260, and in published U.S. patents application Nos. 20210110505, 20220207642 and 20220385783; and in published PCT applications nos. WO2016153911; WO 2021/072346; and WO2020186234. Each of these patent documents is hereby incorporated by reference herein in its entirety. Of course, a great many other approaches are familiar to those skilled in the art. The artisan is presumed to be familiar with a full range of literature concerning steganography, data hiding and digital watermarking.

Additional aspects, features, combinations, and advantages will be readily apparent with reference to the following figures and the Detailed Description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a signal encoder for encoding a data signal into host digital content.

FIG. 2 is a block diagram of a signal decoder for extracting a data signal from host digital content.

FIG. 3 is a flow diagram illustrating operations of a signal generator.

FIG. 4 is an image highlighting various digital watermark signal strength or characteristic changes (e.g., 0.7%-7.3%) according to a visual mask.

FIG. 5 is a block diagram for a visual mask generator.

FIGS. 6A-6C show an original RGB image and subsequent image processing by the FIG. 5 visual mask generator.

FIG. 7A is a representation of the FIG. 6A original RGB image after creation of a standard deviation (SD) map according to the FIG. 5 visual mask generator.

FIG. 7B is a representation of various SD bands associated with the SD map of FIG. 7A.

FIG. 8 illustrates a Final (visual) mask of the original RGB image (FIG. 6A) generated by the FIG. 5 visual mask generator.

FIG. 9 shows the original RGB image (FIG. 6A) next to a version (right) including a digital watermark signal embedded therein using the FIG. 8 Final (visual) mask.

FIG. 10 shows an Original Image for processing by a Wavelet-based visual mask generator.

FIG. 11 shows 6 different Dual-Tree Wavelet Transform (DTCWT) orientations of the FIG. 10 Original Image.

FIGS. 12A-15B show original images next to their AI-generated visual masks. The original image appears on the left and the visual mask on the right.

FIG. 16A shows a diagram for a spatial attention model, FIG. 16B shows a channel attention model, and FIG. 16C shows a residual block model.

FIGS. 17A-18B show original images next to their AI-generated visual masks. The original image appears on the left and the visual mask on the right.

FIG. 19A represents different digital watermarking strengths embedded within the same image. The top left image includes a weaker embedding strength compared to the bottom right image.

FIG. 19B includes four LPIPS maps corresponding to the embedded images in FIG. 19A.

FIG. 19C includes four threshold maps corresponding to FIGS. 19A & 19B, with color showing areas that violate a LPIPS threshold.

FIG. 20A shows a coarse LPIPS threshold visual mask from an original (unembedded) image built from digital watermark embedding strengths 2.

FIG. 20B shows an image embedded using the FIG. 20A visual mask.

FIG. 21 includes Table 1 and Table 2.

### DETAILED DESCRIPTION

### Introduction

There are two (2) main sections that follow in this Detailed Description: I. Signal Encoding and Decoding, and II. Visual Masks for Digital Watermarking of Digital Imagery. These sections and their assigned headings are provided merely to help organize the Detailed Description. Of course, description and implementations under one such section are intended to be combined and implemented with description and implementations from the other such section headings. Thus, the section and headings in this document should not be interpreted as limiting the scope of the description.

### I. Signal Encoding and Decoding

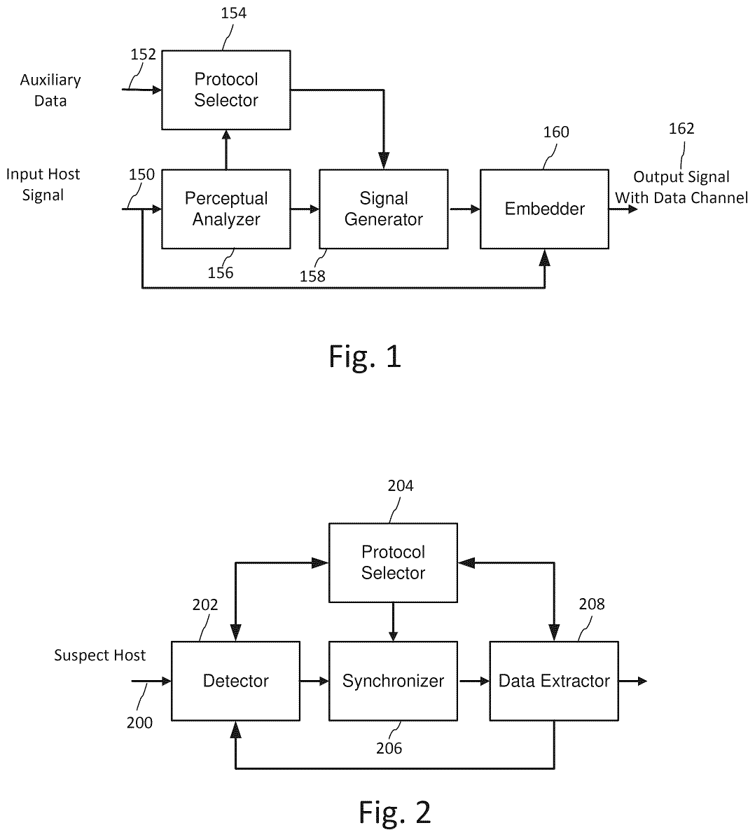

FIG. 1 is a block diagram of a signal encoder for encoding a signal within digital content (e.g., a digital asset such as a digital image, digital video, digital artwork, digital 3D models, digital photographs, PDFs, text documents, digital graphics, or designs). We sometimes refer to the signal as an “encoded signal,” “embedded signal” or “digital watermark signal.” We use the term “signal embedder” interchangeably with “signal encoder.” More generally, we use the terms “encoder” and “embedder” interchangeably. One example of a signal encoder or a signal embedder is a “digital watermark embedder” or “digital watermark encoder.” FIG. 2 is a block diagram of a compatible signal decoder for extracting a payload from a signal encoded within the digital content. We use the terms “read,” “detect,” and “decode” interchangeably. Similarly, we use the terms “decoder,” “reader” and “detector” interchangeably.

Encoding and decoding is typically applied digitally. For example, the encoder generates an output including an embedded signal that can be converted to a rendered form, such as viewable digital content, PDF, displayed image or video, or other viewable digital form. Prior to decoding, and if in an analog form, a decoding device obtains an image or stream of images and converts (if in analog form) it to an electronic signal, which is digitized and processed by signal decoding modules.

Inputs to the signal encoder include a host signal 150 and auxiliary data 152. The host signal in this context can be the target digital content. The objectives of the encoder include encoding a robust signal with desired capacity per unit of host signal, while maintaining perceptual quality within a human perceptual quality constraint. Human perceptual quality refers to the extent to which a modification of content is perceptible to a human viewer or listener, as determined based on a human perceptual model. In some cases, there may be very little variability or presence of a host signal, in which case, there is little host interference, on the one hand, yet little host content in which to mask the presence of the data channel visually. Some examples include a region of digital content that is devoid of much pixel variability (e.g., a single, uniform color).

The auxiliary data 152 includes the variable data information (e.g., payload) to be conveyed in the data channel, possibly along with other protocol data used to facilitate the communication.

The protocol defines the manner in which the signal is structured and encoded for robustness, perceptual quality, or data capacity. For any given application, there may be a single protocol, or more than one protocol. Examples of multiple protocols include cases where there are different versions of the channel, different channel types (e.g., several signal layers within a host signal). Different protocol versions may employ different robustness encoding techniques or different data capacity. Protocol selector module 154 determines the protocol to be used by the encoder for generating a data signal. It may be programmed to employ a particular protocol depending on the input variables, such as user control, application specific parameters, or derivation based on analysis of the host signal.

Perceptual analyzer module 156 analyzes the input host signal to determine parameters for controlling signal generation and embedding, as appropriate. It is not necessary in certain applications, while in others it may be used to select a protocol and/or modify signal generation and embedding operations. For example, when encoding in a host signal that will be printed or displayed, the perceptual analyzer 156 may be used to ascertain color content and masking capability of the host digital content. In some cases, perceptual analyzer 156 generates or obtains a visual mask which an embedder can use to help guide embedding. See Section II for even more details of generating and utilizing visual masks.

The embedded signal may be included in one of the layers or channels of the digital content, e.g., corresponding to: i) one or more color channels of the digital content, e.g., Red, Green, Blue (RGB); ii) Luminance, Chrominance, or in a CIELAB channel (L*, a*, b*); iii) YUV channel; iv) components of a color model (Lab, HSV, HSL, etc.); v) channels corresponding to Cyan, Magenta, Yellow and/or Black, a spot color layer (e.g., corresponding to a Pantone color), which are specified to be used to print the digital content; vi) audio samples; vii) a coating (e.g., varnish, UV layer, lacquer, sealant, extender, primer, etc.); viii) other material layer (metallic substance, e.g., metallic ink or stamped foil where the embedded signal is formed by stamping holes in the foil or removing foil to leave dots of foil); ix) etc.

The above are typically specified in a digital content file and are manipulated by an encoder. For example, an encoder is implemented as software modules of a plug-in to Adobe Photoshop or Illustrator processing software. Such software can be specified in terms of image layers or image channels. The encoder may modify existing layers, channels or insert new ones. A plug-in can be utilized with other image or audio processing software, e.g., for Adobe Illustrator.

The perceptual analysis performed in the encoder depends on a variety of factors, including color or colors of the embedded signal, resolution of the encoded signal, dot structure and screen angle used to print image layer(s) with the encoded signal, content within the layer of the encoded signal, content within layers under and over the encoded signal, etc. The perceptual analysis may lead to the selection of a color or combination of colors in which to encode the signal that minimizes visual differences due to inserting the embedded signal in an ink layer or layers within the digital content. This selection may vary per embedding location of each signal element. Likewise, the amount of signal at each location may also vary to control visual quality. The encoder can, depending on the associated print technology in which it is employed, vary embedded signal by controlling parameters such as: i) dot shape, ii) signal amplitude at a dot, iii) ink quantity at a dot (e.g., dilute the ink concentration to reduce percentage of ink), iv) structure and arrangement of dot cluster or “bump” shape at a location of a signal element or region of elements. An arrangement of ink applied to x by y two-dimensional array of neighboring locations can be used to form a “bump” of varying shape or signal amplitude, as explained further below.

The ability to control printed dot size and shape is a particularly challenging issue and varies with print technology. Dot size can vary due to an effect referred to as dot gain. The ability of a printer to reliably reproduce dots below a particular size is also a constraint.

The encoded signal may also be adapted according to a blend model which indicates the effects of blending the ink of the signal layer with other layers and the substrate.

In some cases, a designer may specify that the encoded signal be inserted into a particular layer. In other cases, the encoder may select the layer or layers in which it is encoded to achieve desired robustness and visibility (visual quality of the digital content in which it is inserted).

The output of this analysis, along with the rendering method (display or printing device) and rendered output form (e.g., ink and substrate) may be used to specify encoding channels (e.g., one or more color channels), perceptual models, and signal protocols to be used with those channels. Please see, e.g., the work on visibility and color models used in perceptual analysis in U.S. application Ser. No. 14/616,686 (U.S. Pat. No. 9,380,186), Ser. No. 14/588,636 (U.S. Pat. No. 9,401,001) and Ser. No. 13/975,919 (U.S. Pat. No. 9,449,357), Patent Application Publication 20100150434 (now U.S. Pat. No. 9,449,357), and U.S. Pat. No. 7,352,878, which are each hereby incorporated by reference in its entirety.

The signal generator module 158 operates on the auxiliary data and generates a data signal according to the protocol. It may also employ information derived from the host signal, such as that provided by perceptual analyzer module 156, to generate the signal. For example, the selection of data code signal and pattern, the modulation function, and the amount of signal to apply at a given embedding location may be adapted depending on the perceptual analysis, and in particular on a perceptual model and perceptual mask (or “visual mask”) that it generates. The signal encoder may also comprise one or models, such as encoder, decoder, and generative adversarial network models trained using machine-learning. The encoder may employ models, such as neural networks (e.g., convolutional neural networks) trained using adversarial machine-learning to optimize perceptual quality and watermark robustness. Please see below and the incorporated patent documents for additional aspects of this process.

Embedder module 160 takes the data signal and modulates it onto a channel by combining it with the host signal. The host signal may include imagery (e.g., digital image or video) and/or audio. The operation of combining may be an entirely digital signal processing operation, such as where the data signal modulates the host signal digitally, may be a mixed digital and analog process or may be purely an analog process (e.g., where rendered output layers are combined). As noted, an encoded signal may occupy a separate layer or channel of the digital content file. This layer or channel may get combined into an image in the Raster Image Processor (RIP) prior to printing or may be combined as the layer is printed under or over other image layers on a substrate. If video or audio, an encoded layer may be combined with the video or audio during or before rendering of same.

There are a variety of different functions for combining the data and host in digital operations. One approach is to adjust the host signal value as a function of the corresponding data signal value at an embedding location, which is controlled according to the perceptual model and a robustness model for that embedding location. The adjustment may alter the host channel by adding a scaled data signal or multiplying a host value by a scale factor dictated by the data signal value corresponding to the embedding location, with weights or thresholds set on the amount of the adjustment according to perceptual model, robustness model, available dynamic range, and available adjustments to elemental ink structures (e.g., controlling halftone dot structures generated by the RIP). Weights may be distributed, e.g., unevenly, between different color channels (RGB) of digital content. The adjustment may also be altering by setting or quantizing the value of a pixel to particular signal element value.

As detailed further below, the signal generator produces a data signal with data elements that are mapped to embedding locations in the data channel. These data elements are modulated onto the channel at the embedding locations. Again, please see the documents incorporated herein for more information on variations.

The operation of combining a signal with other digital content may include one or more iterations of adjustments to optimize the modulated host for perceptual quality or robustness constraints. One approach, for example, is to modulate the host so that it satisfies a perceptual quality metric as determined by perceptual model (e.g., visibility model) for embedding locations across the signal. Another approach is to modulate the host so that it satisfies a robustness metric across the signal. Yet another is to modulate the host according to both the robustness metric and perceptual quality metric derived for each embedding location. The incorporated documents provide examples of these techniques. Below, we highlight a few examples.

For digital content including color images or color elements, the perceptual analyzer generates a perceptual model that evaluates visibility of an adjustment to the host by the embedder and sets levels of controls to govern the adjustment (e.g., levels of adjustment per color direction, and per masking region). This may include evaluating the visibility of adjustments of the color at an embedding location (e.g., units of noticeable perceptual difference in color direction in terms of CIE Lab values), Contrast Sensitivity Function (CSF), spatial masking model (e.g., using techniques described by Watson in US Published Patent Application No. US 2006-0165311 A1, which is incorporated by reference herein in its entirety), etc. One way to approach the constraints per embedding location is to combine the data with the host at embedding locations and then analyze the difference between the encoded host with the original. The rendering process may be modeled digitally to produce a modeled version of the embedded signal as it will appear when rendered. The perceptual model then specifies whether an adjustment is noticeable based on the difference between a visibility threshold function computed for an embedding location and the change due to embedding at that location. The embedder then can change or limit the amount of adjustment per embedding location to satisfy the visibility threshold function. Of course, there are various ways to compute adjustments that satisfy a visibility threshold, with different sequences of operations. See, e.g., U.S. Pat. Nos. 7,352,878, 9,380,186, 9,401,001, 9,449,357, and US Patent Application Publication 20100150434.

The embedder also computes a robustness model in some embodiments. The computing a robustness model may include computing a detection metric for an embedding location or region of locations. The approach is to model how well the decoder will be able to recover the data signal at the location or region. This may include applying one or more decode operations and measurements of the decoded signal to determine how strong or reliable the extracted signal is. Reliability and strength may be measured by comparing the extracted signal with the known data signal. Below, we detail several decode operations that are candidates for detection metrics within the embedder. One example is an extraction filter which exploits a differential relationship between a signal element and neighboring content to recover the data signal in the presence of noise and host signal interference. At this stage of encoding, the host interference is derivable by applying an extraction filter to the modulated host. The extraction filter models data signal extraction from the modulated host and assesses whether a detection metric is sufficient for reliable decoding. If not, the signal may be re-inserted with different embedding parameters so that the detection metric is satisfied for each region within the host digital content where the signal is applied.

Detection metrics may be evaluated such as by measuring signal strength as a measure of correlation between the modulated host and variable or fixed data components in regions of the host or measuring strength as a measure of correlation between output of an extraction filter and variable or fixed data components. Depending on the strength measure at a location or region, the embedder changes the amount and location of host signal alteration to improve the correlation measure. These changes may be particularly tailored so as to establish sufficient detection metrics for both the payload and synchronization components of the embedded signal within a particular region of the host digital content.

The robustness model may also model distortion expected to be incurred by the modulated host, apply the distortion to the modulated host, and repeat the above process of measuring visibility and detection metrics and adjusting the number of alterations so that the data signal will withstand the distortion. See, e.g., U.S. Pat. Nos. 9,380,186, 9,401,001 and 9,449,357 for image related processing; each of these patent documents is hereby incorporated herein by reference.

As noted, the signal encoder may comprise one or more trained network models (e.g., deep learning models utilizing convolutional neural networks (CNNs) and/or recurrent neural networks (RNNs)) optimize the embedding of a variable watermark payload in the host signal for robustness to attacks and perceptual quality. These trained network models are employed within the signal encoder to produce the modulated host, carrying the auxiliary data. The digital watermarking may occur as the digital asset is generated. For example, a payload can be inserted into a digital asset during AI asset generation. Machine trained encoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

This modulated host is then output as an output signal 162, with an embedded data channel. The operation of combining also may occur in the analog realm where the data signal is transformed to a rendered form, such as a layer of ink, including an overprint or underprint, or a stamped, etched, or engraved surface marking. In the case of video display, one example is a data signal that is combined as a graphic overlay to other video content on a video display by a display driver. Another example is a data signal that is overprinted as a layer of material, engraved in, or etched onto a substrate, where it may be mixed with other signals applied to the substrate by similar or other marking methods. In these cases, the embedder employs a predictive model of distortion and host signal interference and adjusts the data signal strength so that it will be recovered more reliably. The predictive modeling can be executed by a classifier that classifies types of noise sources or classes of host signals and adapts signal strength and configuration of the data pattern to be more reliable to the classes of noise sources and host signals.

The output 162 from the embedder signal typically incurs various forms of distortion through its distribution or use. This distortion is what necessitates robust encoding and complementary decoding operations to recover the data reliably.

Turning to FIG. 2, a signal decoder receives a suspect host signal 200 and operates on it with one or more processing stages to detect a data signal, synchronize it, and extract data. The detector is paired with input device in which a sensor or other form of signal receiver captures an analog form of the signal and an analog to digital converter converts it to a digital form for digital signal processing. Though aspects of the detector may be implemented as analog components, e.g., such as preprocessing filters that seek to isolate or amplify the data channel relative to noise, much of the signal decoder is implemented as digital signal processing modules.

The detector 202 is a module that detects presence of the embedded signal and other signaling layers. The incoming digital content is referred to as a suspect host because it may not have a data channel or may be so distorted as to render the data channel undetectable. The detector is in communication with a protocol selector 204 to get the protocols it uses to detect the data channel. It may be configured to detect multiple protocols, either by detecting a protocol in the suspect signal and/or inferring the protocol based on attributes of the host signal or other sensed context information. A portion of the data signal may have the purpose of indicating the protocol of another portion of the data signal. As such, the detector is shown as providing a protocol indicator signal back to the protocol selector 204.

The synchronizer module 206 synchronizes the incoming signal to enable data extraction. Synchronizing includes, for example, determining the distortion to the host signal and compensating for it. This process provides the location and arrangement of encoded data elements of a signal within digital content.

The data extractor module 208 gets this location and arrangement and the corresponding protocol and demodulates a data signal from the host. The location and arrangement provide the locations of encoded data elements. The extractor obtains estimates of the encoded data elements and performs a series of signal decoding operations.

As detailed in examples below and in the incorporated documents, the detector, synchronizer, and data extractor may share common operations, and in some cases may be combined. For example, the detector and synchronizer may be combined, as initial detection of a portion of the data signal used for synchronization indicates presence of a candidate data signal, and determination of the synchronization of that candidate data signal provides synchronization parameters that enable the data extractor to apply extraction filters at the correct orientation, scale and start location. Similarly, data extraction filters used within data extractors may also be used to detect portions of the data signal within the detector or synchronizer modules. The decoder architecture may be designed with a data flow in which common operations are re-used iteratively or may be organized in separate stages in pipelined digital logic circuits so that the host data flows efficiently through the pipeline of digital signal operations with minimal need to move partially processed versions of the host data to and from a shared memory, such as a RAM memory.

The detector module 202 may alternatively comprise one or more trained network models (e.g., deep learning models utilizing convolutional neural networks (CNNs) and/or recurrent neural networks (RNNs)) optimize the detection of a variable watermark payload in a host signal. These trained network models are employed within the signal detector to yield auxiliary data, despite the presence of noise, rotation, scaling, temporal shifts, scaling, etc. Machine trained decoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

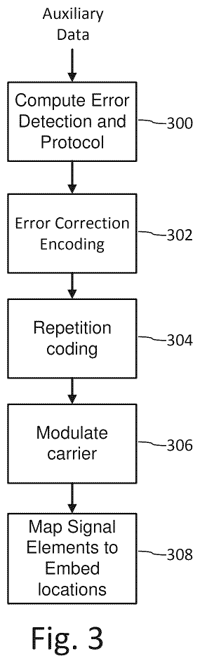

FIG. 3 is a flow diagram illustrating operations of a signal generator. Each of the blocks in the diagram depict processing modules that transform the input auxiliary data (e.g., the payload) into a data signal structure. For a given protocol, each block provides one or more processing stage options selected according to the protocol. In processing module 300, the auxiliary data is processed to compute error detection bits, e.g., such as a Cyclic Redundancy Check, Parity, or like error detection message symbols. Additional fixed and variable messages used in identifying the protocol and facilitating detection, such as synchronization signals may be added at this stage or subsequent stages.

Error correction encoding module 302 transforms the message symbols into an array of encoded message elements (e.g., binary or M-ary elements) using an error correction method. Examples include block codes, convolutional codes, etc.

Repetition encoding module 304 repeats the string of symbols from the prior stage to improve robustness. For example, certain message symbols may be repeated at the same or different rates by mapping them to multiple locations within a unit area of the data channel (e.g., one unit area being a tile of bit cells, bumps or “waxels,” as described further below).

Next, carrier modulation module 306 takes message elements of the previous stage and modulates them onto corresponding carrier signals. For example, a carrier might be an array of pseudorandom signal elements. The data elements of an embedded signal may also be multi-valued. In this case, M-ary or multi-valued encoding is possible at each signal element, through use of different colors, ink quantity, dot patterns or shapes. Signal application is not confined to lightening or darkening an object at a signal element location (e.g., luminance or brightness change). Various adjustments may be made to effect a change in an optical property, like luminance. These include modulating thickness of a layer, surface shape (surface depression or peak), translucency of a layer, etc. Other optical properties may be modified to represent the signal element, such as chromaticity shift, change in reflectance angle, polarization angle, or other forms of optical variation. As noted, limiting factors include both the limits of the marking or rendering technology and ability of a capture device to detect changes in optical properties encoded in the signal. We elaborate further on signal configurations below.

Mapping module 308 maps signal elements of each modulated carrier signal to locations within the channel. In the case where a digital host signal is provided, the locations correspond to embedding locations within the host signal. The embedding locations may be in one or more coordinate system domains in which the host signal is represented within a memory of the signal encoder. The locations may correspond to regions in a spatial domain, temporal domain, frequency domain, or some other transform domain. Stated another way, the locations may correspond to a vector of host signal features at which the signal element is inserted.

Various detailed examples of protocols and processing stages of these protocols are provided in, e.g., U.S. Pat. Nos. 6,614,914, 5,862,260, 6,345,104, 6,993,152 and 7,340,076, which are hereby incorporated by reference in their entirety, and US Patent Publication 20100150434, previously incorporated. More background on signaling protocols, and schemes for managing compatibility among protocols, is provided in U.S. Pat. No. 7,412,072, which is hereby incorporated by reference in its entirety.

In some case, the output of carrier modulation module 306 and/or mapping module 308 is used to generate a watermark signal that can be concatenated or combined with a host image or audio in a trained convolutional neural network (CNN) or recurrent neural networks (RNN) encoder model. These concatenated or combined host image or audio can be used as training input to such models. Different loss functions and optimization strategies can be employed during the training phase to achieve a desired performance, e.g., desired robustness against attacks (scaling, rotation, translation, cropping, etc.).

The above description of signal generator module options demonstrates that the form of the signal used to convey the auxiliary data varies with the needs of the application. As introduced at the beginning of this document, signal design involves a balancing of required robustness, data capacity, and perceptual quality. It also involves addressing many other design considerations, including compatibility, print constraints, scanner constraints, robustness to attacks, etc. We now turn to examine signal generation schemes, and in particular, schemes that employ signaling, and schemes for facilitating detection, synchronization, and data extraction of a data signal in a host channel.

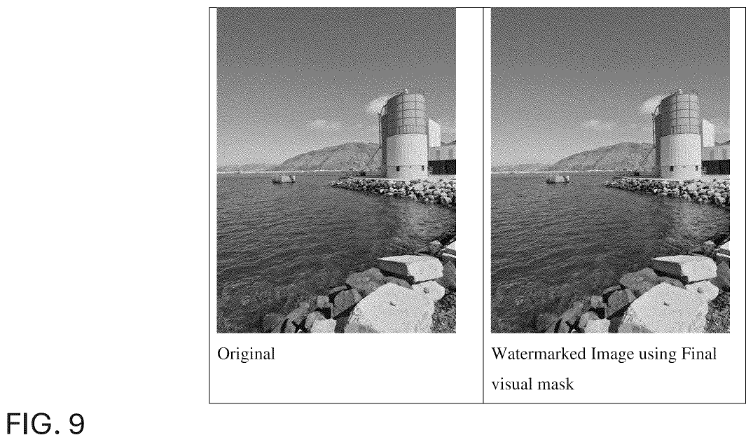

One signaling approach, which is detailed in U.S. Pat. Nos. 6,614,914, and 5,862,260, is to map signal elements to pseudo-random locations within a channel defined by a domain of a host signal. See, e.g., FIG. 9 of U.S. Pat. No. 6,614,914. In particular, elements of a watermark signal are assigned to pseudo-random embedding locations within an arrangement of sub-blocks within a block (referred to as a “tile”). The elements of this watermark signal correspond to error correction coded bits output from an implementation of stage 304 of FIG. 3. These bits are modulated onto a pseudo-random carrier to produce watermark signal elements (block 306 of FIG. 3), which in turn, are assigned to the pseudorandom embedding locations within the sub-blocks (block 308 of FIG. 3). An embedder module modulates this signal onto a host signal by adjusting host signal values at these locations for each error correction coded bit according to the values of the corresponding elements of the modulated carrier signal for that bit.

The signal decoder estimates each coded bit by accumulating evidence across the pseudo-random locations obtained after non-linear filtering a suspect host digital content. Estimates of coded bits at the signal element level are obtained by applying an extraction filter that estimates the signal element at particular embedding location or region. The estimates are aggregated through de-modulating the carrier signal, performing error correction decoding, and then reconstructing the payload, which is validated with error detection.

This pseudo-random arrangement spreads the data signal such that it has a uniform spectrum across the tile. However, this uniform spectrum may not be the best choice from a signal communication perspective since energy of a host digital content may concentrated around DC. Similarly, an auxiliary data channel in high frequency components tends to be more disturbed by blur or other low pass filtering type distortion than other frequency components. A variety of signal arrangements are detailed in U.S. Pat. No. 9,747,656, which are each hereby incorporated by reference in its entirety. This application details several signaling strategies that may be leveraged in the design of encoded signals, in conjunction with the techniques in this document. Differential encoding applies to signal elements by encoding in the differential relationship between a signal element and other signals, such as a background, host elements, or other signal components (e.g., a sync component).

U.S. Pat. No. 6,345,104, building on the disclosure of U.S. Pat. No. 5,862,260, describes that an embedding location may be modulated by inserting ink droplets at the location to decrease luminance at the region, or modulating thickness or presence of line art. Additionally, increases in luminance may be made by removing ink or applying a lighter ink relative to neighboring ink. It also teaches that a synchronization pattern may act as a carrier pattern for variable data elements of a message payload. The synchronization component may be a visible design, within which a sparse data signal (see, e.g., U.S. Pat. No. 11,062,108) or dense data signal is merged. Also, the synchronization component may be designed to be imperceptible, using the methodology disclosed in U.S. Pat. No. 5,862,260.

We further discuss the design, encoding and decoding of signals in more detail. As introduced above, one consideration in the design of an encoded signal is the allocation of signal for data carrying and for synchronization. Another consideration is compatibility with other signaling schemes in terms of both encoder and decoder processing flow. With respect to the encoder, the encoder should be compatible with various signaling schemes, including dense and sparse signaling, so that each signaling scheme may be adaptively applied to different regions of a digital content design, as represented in a digital content, according to the characteristics of those regions. This adaptive approach enables the user of the encoder tool to select different methods for different regions and/or the encoder tool to be programmed to select automatically a signaling strategy that will provide the most robust signal, yet maintain the highest quality image, for the different regions. Additional details regarding sparse digital watermarking are described in Digimarc's published PCT application no. WO 2020186234, which is hereby incorporated herein by reference in its entirety.

One example of the advantage of this adaptive approach is in a design that has different regions requiring different encoding strategies. One region may be blank, another blank with text, another with a graphic in solid tones, another with a particular spot color, and another with variable image content.

With respect to the decoder, this approach simplifies decoder deployment, as a common decoder can be deployed that decodes various types of data signals, including both dense and sparse signals.

As introduced above with reference to FIG. 3, there are stages of modulation/de-modulation in the encoder, so it is instructive to clarify different types of modulation. One stage is where a data symbol is modulated onto an intermediate carrier signal. Another stage is where that modulated carrier is inserted into the host by modulating elements of the host. In the first case, the carrier might be pattern, e.g., a pattern in a spatial domain or a transform domain (e.g., frequency domain). The carrier may be modulated in amplitude, phase, frequency, etc. The carrier may be, as noted, a pseudorandom string of 1's and 0's or multi-valued elements that is inverted or not (e.g., XOR, or flipped in sign) to carry a payload or sync symbol.

As noted in U.S. Pat. No. 9,747,656, carrier signals may have structures that facilitate both synchronization and variable data carrying capacity. Both functions may be encoded by arranging signal elements in a host channel so that the data is encoded in the relationship among signal elements in the host. U.S. Pat. No. 9,747,656 specifically elaborates on a technique for modulating, called differential modulation. In differential modulation, data is modulated into the differential relationship among elements of the signal. In some watermarking implementations, this differential relationship is particularly advantageous because the differential relationship enables the decoder to minimize interference of the host signal by computing differences among differentially encoded elements. In sparse data signaling, there may be little host interference to begin with, as the host signal may lack information at the embedding location.

Another form of modulating data is through selection of different carrier signals to carry distinct data symbols. One such example is a set of frequency domain peaks (e.g., impulses in the Fourier magnitude domain of the signal) or sine waves. In such an arrangement, each set carries a message symbol. Variable data is encoded by inserting several sets of signal components corresponding to the data symbols to be encoded. The decoder extracts the message by correlating with different carrier signals or filtering the received signal with filter banks corresponding to each message carrier to ascertain which sets of message symbols are encoded at embedding locations.

Having now illustrated methods to modulate data into the watermark (either dense or sparse), we now turn to the issue of designing for synchronization. For the sake of explanation, we categorize synchronization as explicit or implicit. An explicit synchronization signal is one where the signal is distinct from a data signal and designed to facilitate synchronization. Signals formed from a pattern of impulse functions; frequency domain peaks or sine waves is one such example. An implicit synchronization signal is one that is inherent in the structure of the data signal.

An implicit synchronization signal may be formed by arrangement of a data signal. For example, in one encoding protocol, the signal generator repeats the pattern of bit cells representing a data element. We sometimes refer to repetition of a bit cell pattern as “tiling” as it connotes a contiguous repetition of elemental blocks adjacent to each other along at least one dimension in a coordinate system of an embedding domain. The repetition of a pattern of data tiles or patterns of data across tiles (e.g., the patterning of bit cells in U.S. Pat. No. 5,862,260) create structure in a transform domain that forms a synchronization template. For example, redundant patterns can create peaks in a frequency domain or autocorrelation domain, or some other transform domain, and those peaks constitute a template for registration. See, for example, U.S. Pat. No. 7,152,021, which is hereby incorporated by reference in its entirety.

The concepts of explicit and implicit signaling readily merge as both techniques may be included in a design, and ultimately, both provide an expected signal structure that the signal decoder detects to determine geometric distortion.

In one arrangement for synchronization, the synchronization signal forms a carrier for variable data. In such arrangement, the synchronization signal is modulated with variable data. Examples include sync patterns modulated with data.

Conversely, in another arrangement, that modulated data signal is arranged to form a synchronization signal. Examples include repetition of bit cell patterns or tiles.

The variable data and sync components of the encoded signal may be chosen so as to be conveyed through orthogonal vectors. This approach limits interference between data carrying elements and sync components. In such an arrangement, the decoder correlates the received signal with the orthogonal sync component to detect the signal and determine the geometric distortion. The sync component is then filtered out. Next, the data carrying elements are sampled, e.g., by correlating with the orthogonal data carrier or filtering with a filter adapted to extract data elements from the orthogonal data carrier. Signal encoding and decoding, including decoder strategies employing correlation and filtering are described in U.S. Pat. No. 9,747,656.

Additional examples of explicit and implicit synchronization signals are provided in previously cited U.S. Pat. Nos. 6,614,914, and 5,862,260. In particular, one example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference in its entirety.

US Publication No. 20120078989, which is hereby incorporated by reference in its entirety, provides additional methods for detecting an embedded signal with this type of structure and recovering rotation, scale, and translation from these methods.

Additional examples of implicit synchronization signals, and their use, are provided in U.S. Pat. Nos. 9,747,656, 7,072,490, 6,625,297, 6,614,914, and 5,862,260, which are hereby incorporated by reference in their entirety. Signal encoders and decoders may also employ network models trained to embed and extract the auxiliary data signal so as to be robust to geometric and temporal transformations, and thus, provide implicit synchronization. In these machine-learning based approaches, portions of the auxiliary data may function as a synchronization signal. Further, the features or encoding domains in which the models are trained to embed and extract the auxiliary data may be selected to be robust to anticipated forms of geometric or temporal transformation (e.g., spatial or temporal scale, rotation, or shift invariant feature sets).

### II. Visual Masks for Digital Watermarking of Digital Imagery

We now describe different visual masking embodiments for digital watermarking of digital imagery (e.g., digital images, digital video, PDF layers, digital artwork, etc.). A visual mask can be generated, e.g., by a perceptual analyzer 156, and/or by a standalone visual mask model, and/or by an artificial intelligence system (e.g., one or more neural networks). A visual mask may include a pixel-by-pixel (or group of pixels) guide (or mapping) on how to adjust or alter a digital watermark signal at that pixel (or group of pixels) for embedding into digital imagery. Values within a visual mask may include, e.g., a percentage value to be applied to a digital watermark signal element at a pixel (or group of pixels) location, a constant value to be combined with a digital watermark signal element at a pixel location (or group of pixels location), or an actual digital watermark signal element itself to alter a pixel value at a location (or group of pixels at a location). A digital watermark embedder can use a visual mask to help guide digital watermark embedding, e.g., by increasing or decreasing digital watermark signal strength at various image locations (e.g., per pixel, per pixel block, and/or per color, etc.). An AI-based watermarking system can use visual masks to help train a watermarking system, or to preprocess imagery prior to embedding.

Assuming a fixed embedding color direction (e.g., chroma, luma, grayscale), the embedding strength of a digital watermark within digital imagery enables different trade-offs of digital watermark imperceptibility and robustness. For example, the stronger (e.g., higher signal amplitude) a digital watermark signal is embedded, the more robust the digital watermark may be to image distortion. Yet, this strong robustness often comes at a visibility cost, e.g., introducing perceptual embedding artifacts due to signal strength. The question then becomes: given a host digital image, how should the embedding strength be selected towards a meaningful balance of digital watermark imperceptibility and robustness?

Commonly, embedding strength has been set to a constant value (e.g., uniform or flat embedding). Different digital imagery, depending on their content, can tolerate different embedding strengths before the digital watermark signal becomes visible. Moreover, different regions of the same image can tolerate different embedding strengths before the watermark signal becomes apparent. For example, in digital imagery depicting a cloudless sky (a flat region) and intense vegetation (a highly textured region), more signal can be hidden in the intense vegetation compared to the cloudless sky while maintaining embedding signal imperceptibility. While simpler to implement, uniform embedding often exhibits suboptimal performance in the digital watermark imperceptibility vs. robustness trade off.

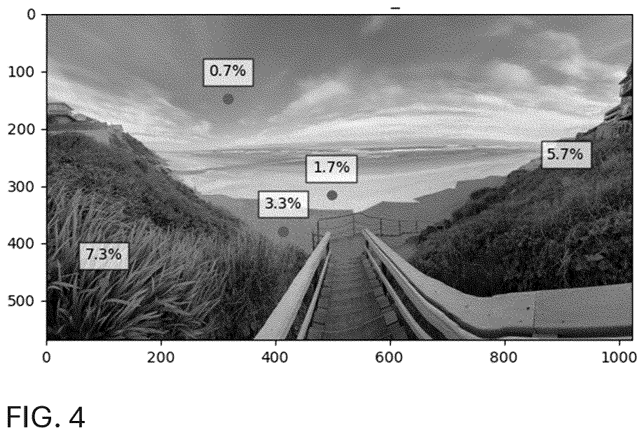

As discussed in this Section II, selection of variable embedding strength can be content adaptive. In one example, embedding strength is driven by content such that it complies with a Just Noticeable Difference (JND) concept. One (1) JND often seeks to find the largest pixel change which maintains imperceptibility with respect to the human visual system (HVS). Some factors influencing JND include image texture, edges, contrast, color, spatial frequencies, and luminance. Moreover, JND is also influenced by factors such as viewing distance, display medium (e.g., device), viewing angle, and observer's viewing acuity to name a few. In the context of digital watermarking, for a given host image, visual masking may involve a task of identifying a “mask” which comprises pixel-wise (or location-wise) embedding strengths each of which results in a digital watermarked host image being at (or within ±0.90 of) 1 JND threshold. FIG. 4 is an example of how embedding magnitudes of digital watermark signal elements can change at specific image locations.

### Embodiment 1: Perceptual Modeling Candidate (PMC)

In this embodiment we describe a visual masking approach based on contrast masking and texture classification. We utilize a Perceptual Modeling Candidate (PMC) module to generate a visual mask for digital watermark embedded. Generally, PMCs are a class of one-shot perceptual models. As used here, a PMC module receives an input digital image and analyzes the input to output a visual mask showing varying watermark embedding strength levels in different image regions. The visual mask provides an indication of digital watermark strength levels that can be applied, e.g., to each of three Red, Green, Blue (RGB) color channels (or other image channel, e.g., grayscale, luma, chroma), for reduced embedded signal imperceptibility while maximizing digital watermark strength for detection.

As discussed above, digital watermark perceptibility can be dependent on multiple factors such as luminance, contrast, color, texture (e.g., flat or busy, organized or random, etc.), and texture irregularity of the image content. Digital watermark spatial resolution (also referred to as “bump size”) can also impact watermark perceptibility when embedded in digital imagery. Image contrast is very low in relatively flat regions of an image and is high in textured regions of an image. However, even in textured image regions, we have found that the amount of signal strength that can be introduced may depend on the nature or type (or characterization) of the texture. (We noticed that general image contrast discussed in J. Wu, et al., “Enhanced Just Noticeable Difference Model for Images with Pattern Complexity,” in IEEE Transactions on Image Processing, vol. 26, no. 6, pp. 2682-2693 June 2017, which is hereby incorporated herein by reference, can be influenced by an extent of regularity or irregularity in a pattern. Their notion is that the HVS is highly adapted to sensing repeated or regular patterns and hence their masking capability is relatively low. The HVS is less sensitive to detecting irregular patterns with many arbitrary gradient orientations. The pattern masking capability is higher in irregular patterns compared to regular patterns.)

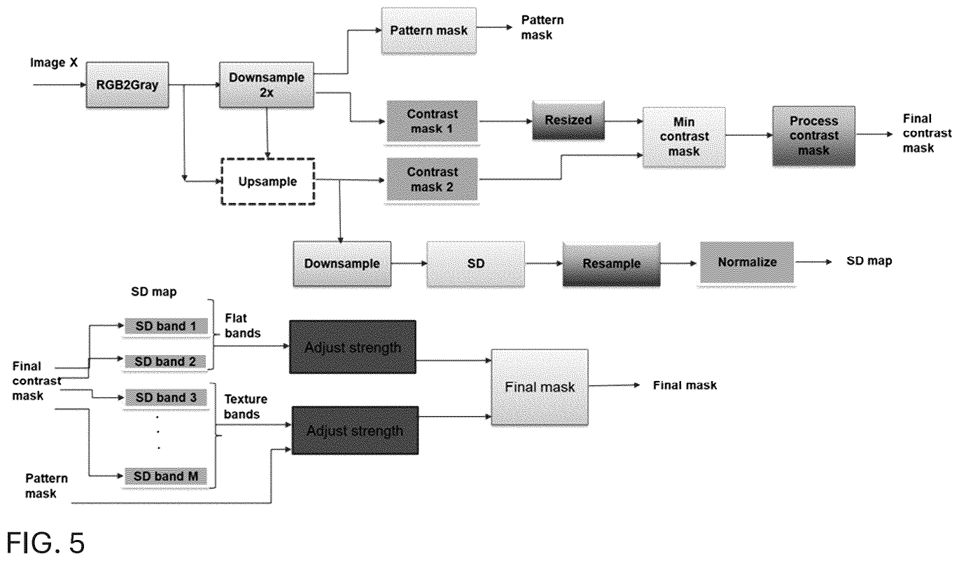

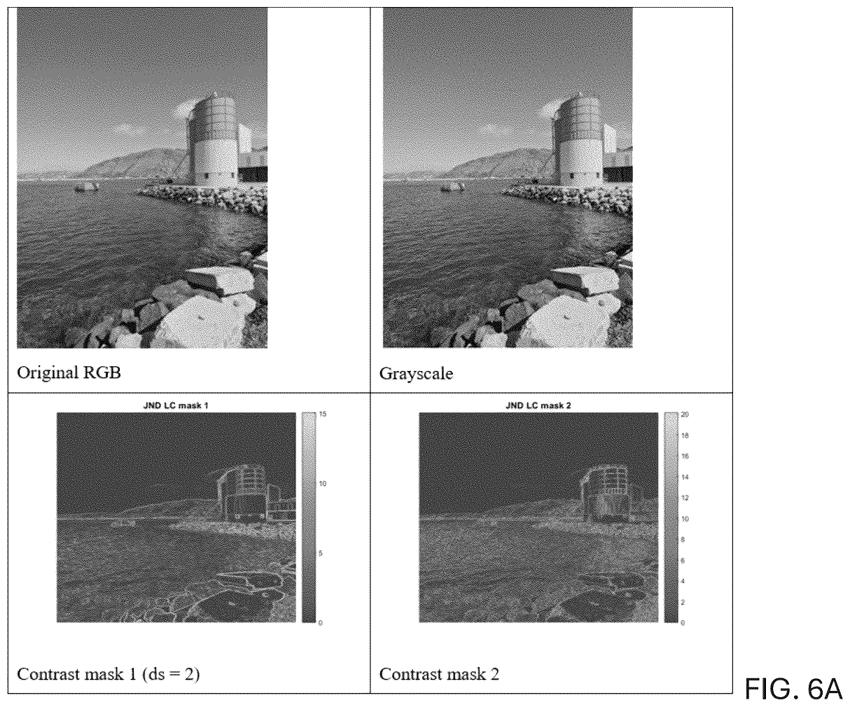

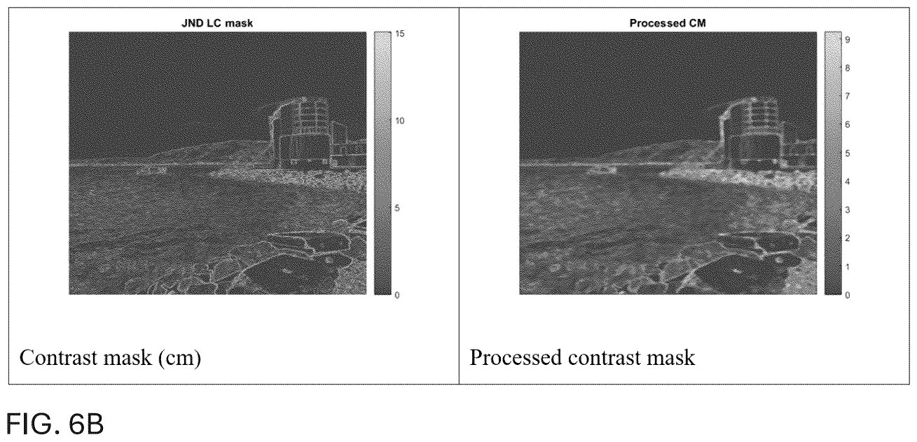

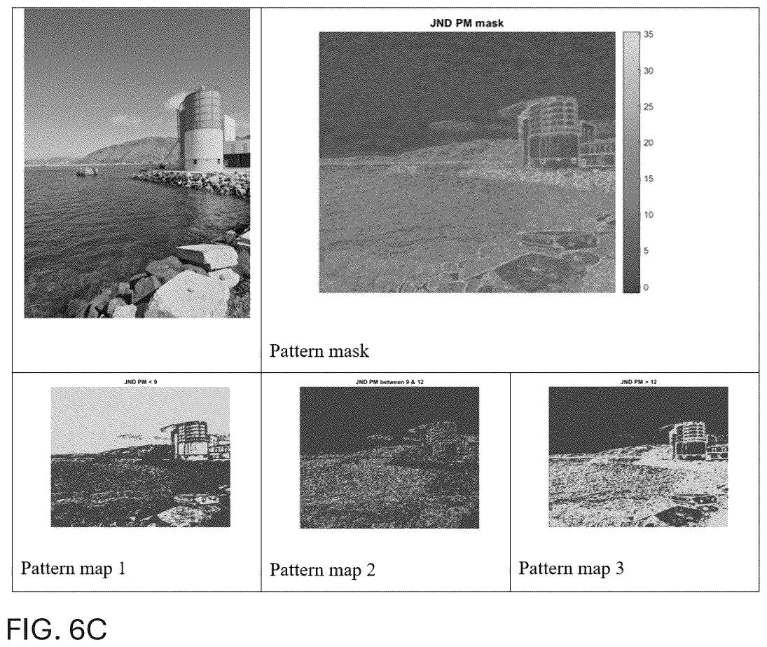

With reference to FIG. 5, digital imagery (“Image X”) is processed to achieve a Pattern Mask, Final contrast mask, and an SD Map (through which different texture bands can be separated out based, e.g., on neighborhood standard deviation (“SD”)). A Final (visual) Mask can then be generated through use applying different texture bands for the Final contrast mask and the Pattern mask. In even more detail, Image X can be represented by its various color channels (or, alternatively, via luminance and/or chrominance). In the illustrated example, this is via Red (R), Green (G), Blue (B) channels, e.g., each represented as a greyscale image or as a composite RGB greyscale image. See FIG. 6A. The greyscale image(s) are scaled, e.g., upsampled (e.g., 1.0×-3.5×) and downsampled (e.g., 1.2×-3.5×), and then contrast maps are generated from each scaled image path. For example, the contrast masks 1 and 2 can be generated using the methodology described in the above Wu paper, e.g., see Wu's equation 11 et al. Alternatively, a contrast mask can be developed using Laplacian filters (e.g., using a second derivative of the image, highlighting regions where the intensity changes abruptly; thereby enhancing edges and transitions, effectively boosting the local contrast), Sobel Operator (e.g., used to create a contrast mask by emphasizing edges and transitions in intensity), High-Pass Filters (e.g., by remove low-frequency components (smooth areas) from an image, leaving behind high-frequency components (edges and details), thereby enhancing local contrast), Global Contrast Adjustment (e.g., histogram redistribution, and contrast stretching to enhance overall contrast), Adaptive Histogram Equalization (using several histograms corresponding to distinct sections of the image and using them to redistribute the lightness values, which enhances contrast locally without affecting the global contrast too much), Statistical Approach (e.g., calculating standard deviation of pixel values within a local window around each pixel, where higher standard deviations indicate higher local contrast), and Local Entropy (e.g., measuring entropy in localized areas of the image to indicate contrast, with higher entropy values reflecting more complex and detailed regions). Contrast mask 1 and Contrast mask 2 are also shown in FIG. 6A (bottom images), where increasing values (represented from blue to yellow) indicate increasing contrast.

A contrast mask can be a minimum of the two contrast masks (Min contrast mask) at each pixel or group of pixels. The downsampled contrast mask suppresses the contribution of very fine texture to contrast masking. See FIG. 6B, left side. The Min contrast mask can be further processed (“Process contrast mask” in FIG. 5) by downsampling by a factor (e.g., 4-16, e.g., 4, 6, 8, 10, 12 or 16) applying a median filter (e.g., with a kernel size [5,5]) and resizing back to image dimensions. Of course, specific values for filters and downsampling, et. can be heuristically determined and can be adjusted as needed. This processing reduces the spatial variability of the Final contrast mask and helps to improve digital watermark robustness during detection while not adversely impacting the visibility. See FIG. 6B, right side (with contrast increasing shown from blue (low) to yellow (high)).

The Pattern mask module in FIG. 5 identifies image variation, e.g., representing both luminance contrast and pattern complexity (e.g., higher or lower complexity, type of complexity, character of complexity, etc.). See FIG. 6C, where increasing contrast is represented in colors. Originally, a Pattern mask was computed based on the implementation in the above-referenced Wu paper (equation 8) and involved quantifying image variation in the orientation of the gradients. However, we found that in a digital watermark context, the pattern mask based on the Wu implementation, which is a product of a function of luminance contrast and pattern complexity, tends to overestimate masking especially in relatively flat or low texture regions. Our preferred pattern mask is generated differently. In the Wu paper, a maximum of contrast and pattern masking is computed to obtain a total spatial masking. However, we have found for our digital watermarking purposes that a pattern mask overestimates the visibility of the spatial masking especially in relatively flat and low texture regions of an image. In a preferred implementation, and still using the Wu equation 8, the Pattern masking is not applied directly but is separated into a plurality of pattern maps (e.g., three or more pattern maps based on a pattern mask value at each pixel). See FIG. 6C, lower 3 windows. Each of plurality of pattern maps are mutually exclusive. For example, a pixel can only activate one of the maps based on whether the pattern mask value at that pixel location is less than 9, between 9 and 12 or greater than 12. Alternative Pattern masks can be developed from Texture Analysis Techniques (e.g., Gray-Level Co-occurrence Matrix (GLCM), Gabor Filters and Local Binary Patterns (LBP)), Edge Detection Techniques (Canny Edge Detectors, and Sobel, Prewitt, and Roberts Cross Operators), Frequency Domain Analysis (Fourier Transform, Wavelet Transforms), Segmentation Techniques (Thresholding, Watershed Algorithm, K-means Clustering) and Machine-Learning approaches such as Convolutional Neural Networks (CNNs) (e.g., networks trained to recognize complex patterns in images and can be used to generate detailed and accurate pattern masks) and Support Vector Machines (SVM) (e.g., networks trained on labeled pattern data, SVMs can classify image areas into patterned or non-patterned, producing a discriminative mask).

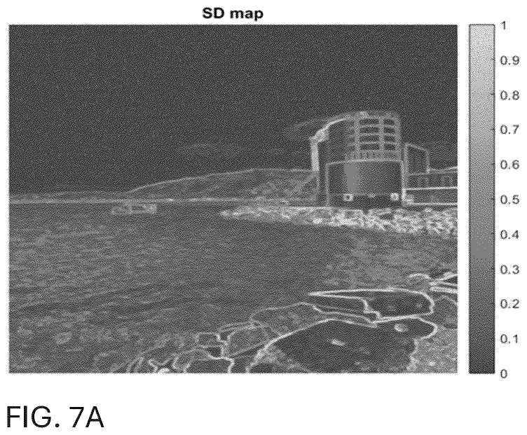

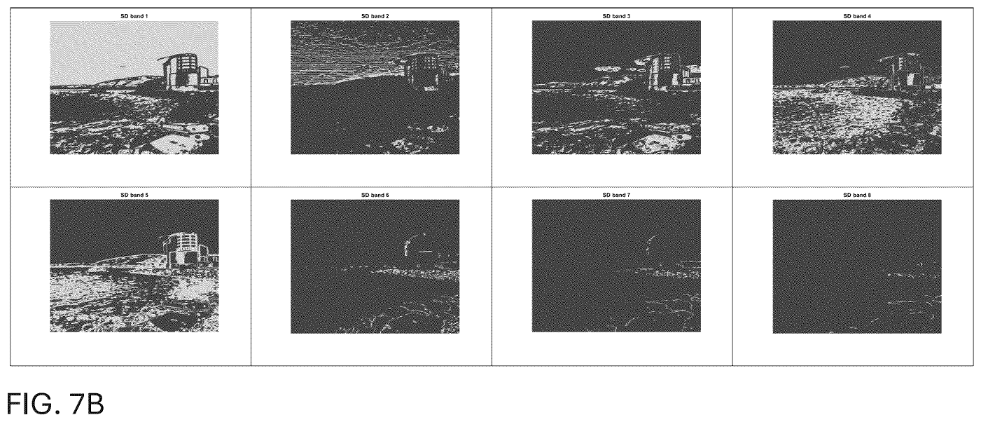

Returning to FIG. 5, a texture classifier (or SD map, see FIG. 7A) utilizes standard deviation (SD) within a local neighborhood of pixels (e.g., 4×4, 8×8, 16×16 local pixel neighborhood) of the grayscale image. The SD values can be clipped and normalized. Based on a range of SD values, a given image pixel (or group of average or mean values of image pixels) is classified into M (a positive integer) different texture bands. For example, if eight bands are used, the initial two bands represent relatively flat areas while bands 3 through 8 indicate increasing levels of texture busy-ness. A strength of the Final contrast mask is adjusted on texture busy-ness (M bands) and Pattern mask. The input grayscale Image X is used for identifying which texture band a pixel falls into based on computing the standard deviation in its neighborhood region. For example, Image X is downsampled, e.g., by a factor of 2-8, e.g., 5, and the standard deviation is computed on 6×6 image pixel regions (or 4×4, or 6×6, or 8×8 pixel regions). Individual bands are represented in FIG. 7B.

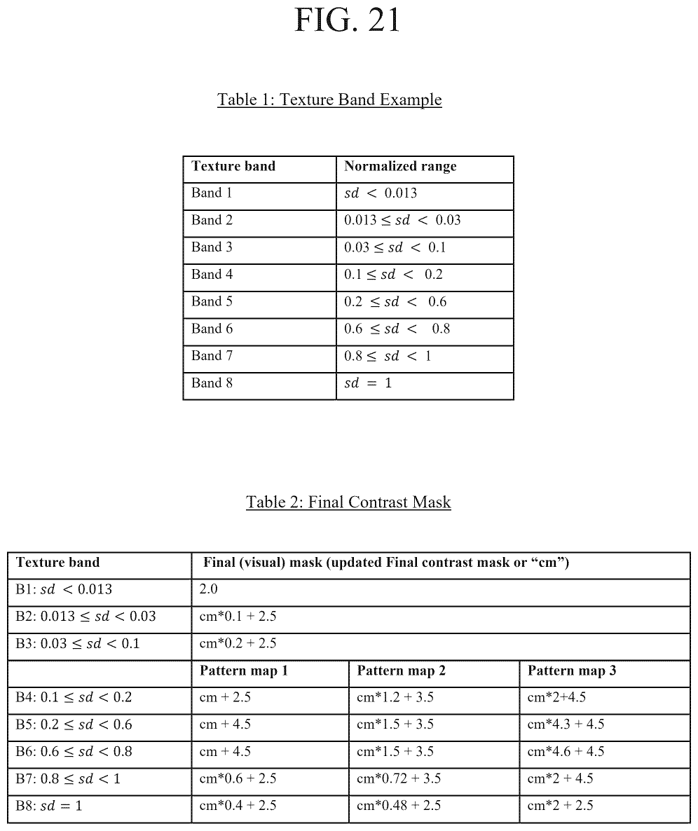

The following parameters in FIG. 21, Table 1 & Table 2 were heuristically determined and of course could be altered based on image resolution and/or digital watermark bump size. The standard deviation (sd) is clipped to a maximum value of, e.g., 60 (maxSD), as anything higher has not been found not contributing to improved texture classification. The final sd is obtained by normalizing sd/maxSD. The range of sd values determines which texture band a particular image pixel falls into. See FIG. 21, Table 1.

The Final (visual) mask is obtained by adjusting watermark embedding strength (adjusting signal amplitude or tweak value) of the Final contrast mask at each pixel (or group of pixels) based on the texture band and pattern map. The pattern maps only impact the Final contrast mask values of the textured bands. See, e.g., FIG. 21, Table 2.

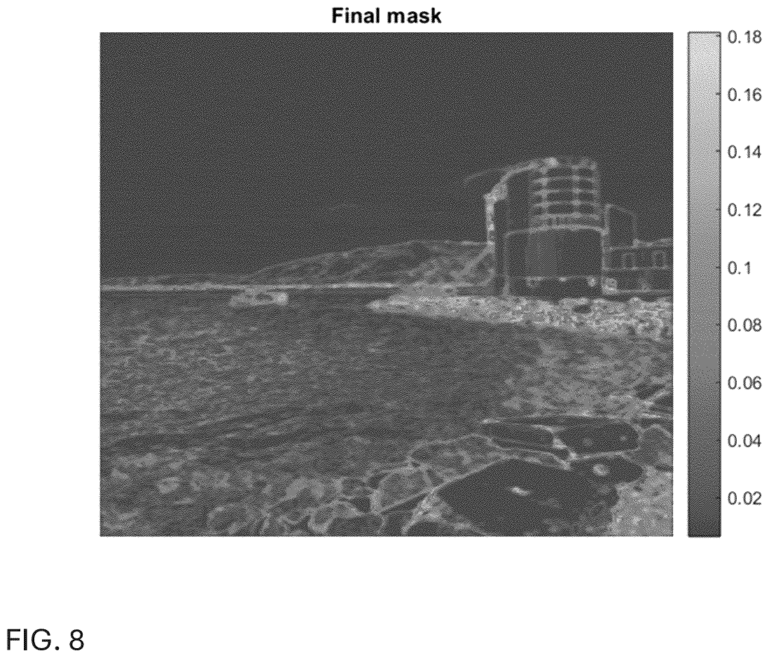

For example, if texture classifier (or SD map) has a value of 0.35 at pixel location (121, 345) of an image, then texture band 5 (SD band) is used at that pixel location. The Pattern mask also has a value between 9 and 12 at this pixel value, so pattern map 2 is used. Thus, equation “cm*1.5+3.5” is used to determine the final masking value at that pixel location (121, 345). Additionally, and not shown in FIG. 21, Table 2, luminance adaptation may be integrated into the texture bands which are flat (band 1) or with low texture (bands 2 or 3) instead of the constant in their equations. A final visual mask is shown in FIG. 8.

An original image is shown in FIG. 9 (left) and its corresponding digital watermarked image using the above visual mask on the right side. This yields excellent visibility vs. robustness.

### Embodiment 2: Wavelet-Based Visual Masks

This embodiment utilizes visual masking approach based on wavelet decomposition. Wavelet decomposition is attractive as it provides a blend between frequency and spatial resolution, properties useful for building visual masks.

In visual masking, we strive to identify image regions with no image content (flat) and image regions having textures of increasing complexity and contrast. Texture complexity can be measured in terms of frequencies present (energy and amount-simple stripy pattern compared to grassy field). Texture analysis is carried out at correct spatial resolution as regions with textures allow up to 10-15× more digital watermark signal to be placed without being visibly noticeable to a HVS compared to flat regions. Spatial resolution also plays a role as image areas having complex texture (allowing for increase watermark signal hiding) should not “spill over” into neighboring flat region (blue sky) where human vision is relatively more sensitive.

Frequency decomposition for texture complexity analysis can be achieved by a moving window Discrete Fourier Transform (DFT), but due to fixed window size the resolution of such approach would not be sufficient for segmenting low-complexity (flat) regions. Frequency decomposition should be translationally invariant, e.g., a mask of shifted image should be a spatially shifted mask. In general, traditional wavelets like Haar, Daubechies, Biorthogonal, Coiflets, and Symlets are not translationally invariant. Lack of invariance means that the wavelet transform of an image can change if the image is shifted, resulting in a different visual mask.

A Dual-Tree Wavelet Transform (DTCWT) provides approximate translation invariance while retaining multiresolution properties of wavelets while also offering directional sensitivity. See, e.g., Ivan W. Selesnick et al, The Dual-Tree Complex Wavelet Transform: A coherent framework for multiscale signal and image processing, IEEE SIGNAL PROCESSING MAGAZINE, November 2005, pp. 123-151, which is hereby incorporated herein by reference in its entirety. A DTCWT of an image with N levels returns N arrays of progressively smaller image size, each array having 6 orientations (corresponding to spatial rotations) and each element being a complex number. An absolute value of complex element is approximately translation invariant and measures amount of energy present at orientation O, spatial location X, Y at level (scale) L. Stated another way, DTCWT works in levels. First decomposition and first level takes an input image and decomposes it into 6 frequency orientations while analyzing high frequency content and also outputs 2× downsampled residual (kind of 2× downsampled image). Next level does the same orientation analysis, but on the 2× downsampled version and so on. In the below algorithm, a “Level 2” analysis works on sub-bands after applying the above decomposition 2 times leading to assessment of frequency bands that are the second highest frequency bands.

One implementation of a DTWCT-based masking algorithm includes:

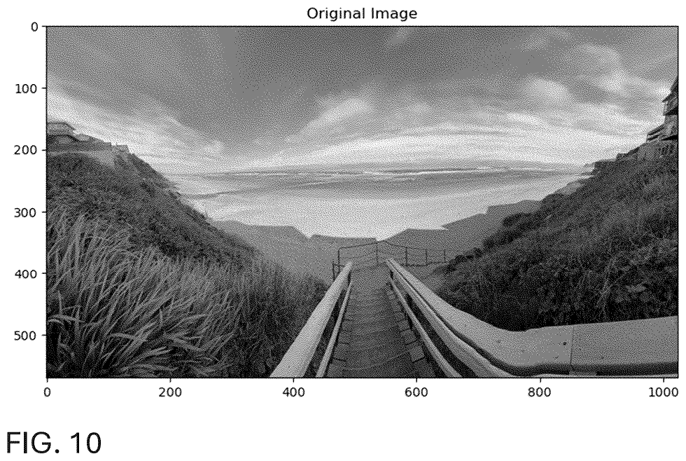

Input: A digital image represented with RGB channels (e.g., FIG. 10, with approximately 580×1200 pixels).

Output: Grayscale visual mask of same size as input digital image.

### Process:

Step 1: Convert RGB to luminance using, e.g., colorimetric coefficients (e.g., 0.2 R+0.7 G+0.05 B).

Step 2: Perform DTCWT on luminance image using a few levels, take absolute values.

Step 3: Take absolute value of complex DTCWT coefficient to make result shift invariant.

Step 4: Filter coefficients to reduce outliers, for example, a median filter across six orientations and across 3×3 spatial window as amount of masking depends on presence of more than just one frequency/orientation.

Step 5: Predict a visual mask as a linear function of filtered DTCWT coefficients.

Step 6: Upsample the predicted visual mask to original image resolution as Level 2 DTCWT is downsampled.

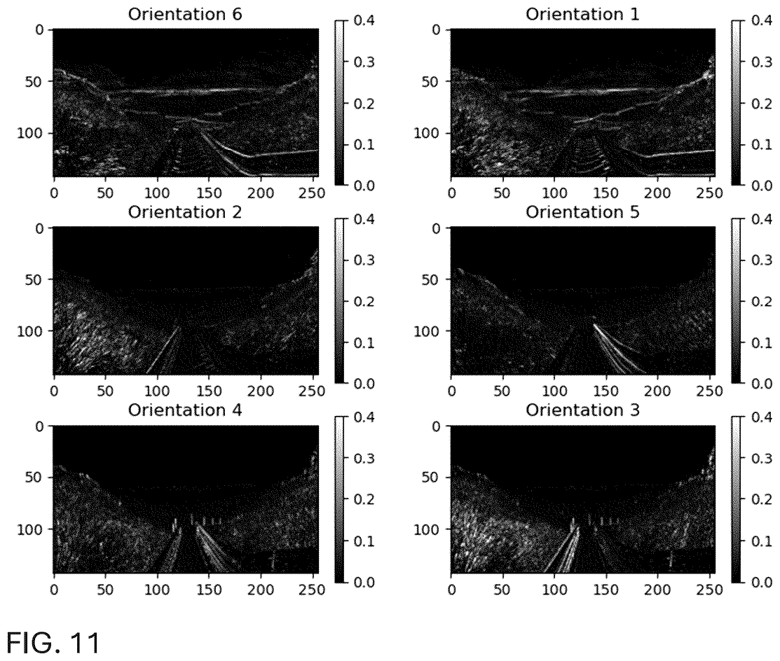

The predicted visual mask can be trained on data from users providing ground truth values of how much mask is allowed at each point in the image to calibrate predicted masks and match values as close as possible. FIG. 11 shows representations of absolute values of complex DTCWT coefficients. Orientations 1 and 6 correlated with horizontal edges, 3 and 4 with vertical edges and 2 and 5 with diagonals.

### Embodiment 3: AI-Based Approaches

In this embodiment, we describe how visual masks are generated using machine-learning and artificial intelligence (AI). Various implementations will be described below.

### Implementation 1:

In this implementation, parameters to be optimized are values of a visual mask itself.

That is, given a color image and a digital watermark tile (or digital watermark signal element), a visual mask with the same height and width as the image is generated.

Step 1: Randomly initialize the visual mask.

Step 2: Embed a digital image using a digital watermark signal according to the visual mask.

Step 3: Measure the perceptual distance between marked and unmarked image (e.g., Mean-Squared-Error, LPIPS, other). This represents a “visibility loss” due to digital watermarking.

Step 4: Compute detection statistics with respect to the marked image (e.g., a detectability measure as described in assignee U.S. Pat. No. 11,188,997, which is hereby incorporated herein by reference in its entirety). This detection statistic represents a “detection loss.”

Step 5: Combine visibility and detection losses. This can be a linear combination, or a weighted version of such, e.g., weighting visibility loss more heavily compared to detection loss. This combination represents an “overall loss.”

Step 6: Adjust the mask coefficients by backpropagation to minimize the overall loss. (For example, a partial derivative is taken of the overall loss with respect to each of the visual mask's entries (back-propagation) and we compute the gradient. The gradient then informs how the mask entries are to be adjusted.)

Step 7: Repeat steps 2-6 until some convergence criteria is met or for a maximum number of permitted iterations.

### Visibility Loss:

Imperceptibility of the digital watermarked image compared to the host or cover image can be measured based on, e.g., a color error, Mean-Squared-Error, and/or LPIPS (Learned Perceptual Image Patch Similarity) distance metric. See Richard Zhang et al., “The Unreasonable Effectiveness of Deep Features as a Perceptual Metric” Proceedings-2018 IEEE/CVF Conference on Computer Vision and Pattern Recognition, CVPR 2018, IEEE Computer Society, pp 586-595. LPIPS measures a distance between two images in a feature space via a pretrained CNN for classification (e.g., AlexNet, Vgg, other) which may be finetuned for the task of measuring image similarity. In theory, the smaller the LPIPS distance between marked and host images, the more similar the images are. Of course, LPIPS is performing well for a large distribution of images. However, exceptions may exist in which this statement for LPIPS does not hold true.

### Detection Statistics Loss:

This detection statistics loss may be based on the detectability measures described in assignee U.S. Pat. No. 11,188,997, as mentioned above. Additional and/or alternative measures may include, e.g., digital watermark synchronization signal measures and negative message correlation metrics. Specifically, we seek to minimize a weighted average of such statistics.

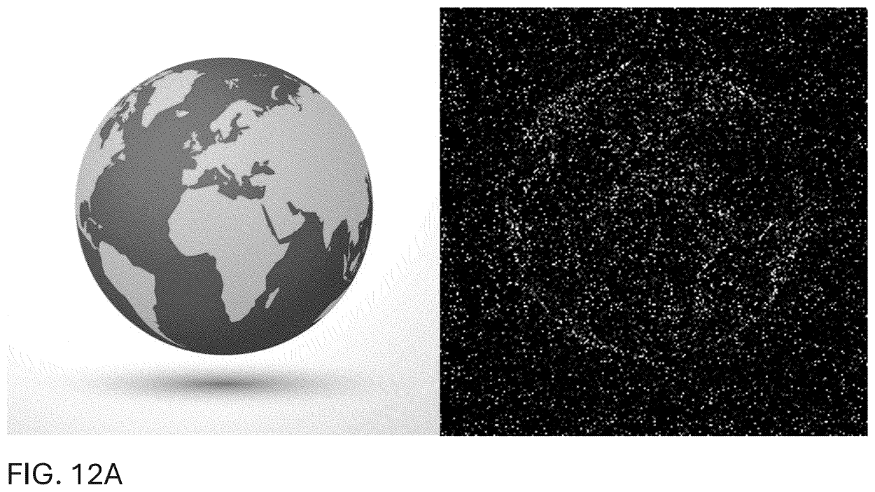

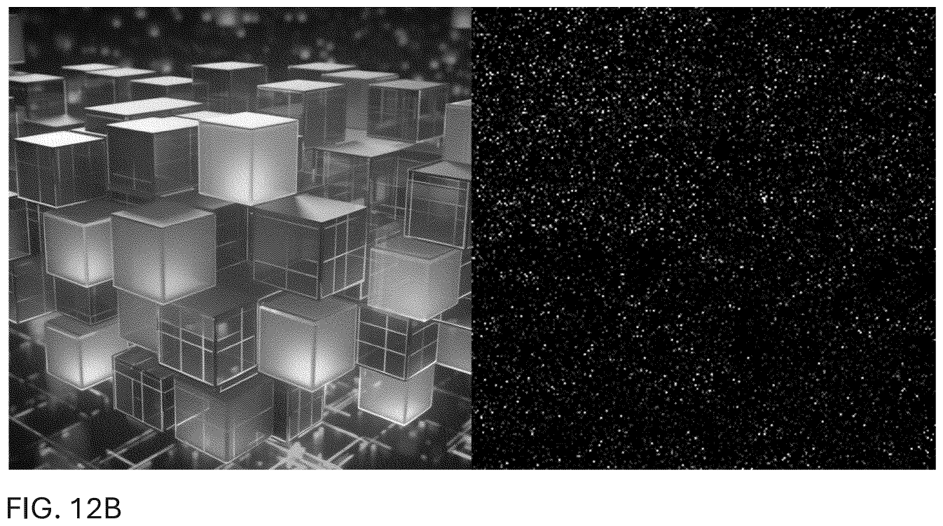

FIGS. 12A & 12B show host images (left side) vs. their corresponding visual masks (right side) generated using this Implementation 1.

### Implementation 2:

This implementation utilizes a Convolutional Neural Network (CNN) architecture that takes as input a color (C) image and outputs a same height/width array of embedding strengths (the visual mask). In contrast to Implementation 1, the visual mask values here are not learnable parameters. This time, the learnable parameters are the kernels of the CNN architecture. In the context of a Convolutional Neural Network (CNN), kernels (also known as filters) are operations (e.g., matrices) used to perform convolution operations on the input data, such as images. These kernels are fundamental to how CNNs function and are key to extracting features from the input data at various levels of abstraction. Algorithmically, we work as follows to obtain a visual mask for an input color image and digital watermark tile.

Step 1: Define the CNN architecture that takes as input a size H×W×C image and outputs a H-W array of embedding strengths on a per pixel (or group of pixels) basis. The depth of a kernel in a given layer corresponds to the number of feature maps (or channels) in the previous layer. For example, if the first layer of a CNN takes a color image as input, the kernels will typically have a depth of 3, corresponding to the RGB channels.

Step 2: Initialize weights of the CNN (e.g., by pretraining). For example, initially, the values in the kernels are set randomly, and they are updated through backpropagation based on a loss function of the network.

Step 3: Perform a forward pass of the input image through the CNN and obtain the visual mask.

Step 4: Embed the image using a digital watermark signal according to the visual mask.

Step 5: Measure the perceptual distance between marked and unmarked image (e.g., Mean-Squared-Error, LPIPS, other). This represents a “visibility loss.”

Step 6: Compute detection statistics with respect to the marked image. See Implementation 1, above, for examples. This represents a “detection loss.”

Step 7: Optionally, compute regularization terms (e.g., L1 (“proportional penalty”)-norm of mask, L2 (“weight decay”)-norm of mask, other). Regularization terms are techniques or modifications used to reduce the training and generalization error.

Step 8: Combine visibility, detection, and regularization losses. This yields an “overall loss.” Here again, one such loss can be weighted more heavily compared to another such loss.

Step 9: Adjust the CNN coefficients by backpropagation.

Step 10: Repeat steps 3-9 until some convergence criteria is met or for a maximum number of permitted iterations.

### Visibility Loss:

The visibility metrics discussed in Implementation 1 can be used here. Optionally, a Euclidean distance term can be added for visibility.

### Detection Statistics Loss:

Same as Implementation 1.

### Regularization Loss:

The entry-wise infinity norm of the mask, e.g., the maximum absolute value of the mask's entries. That is, this term squeezes the maximum embedding strength in the mask to an upper bound during the optimization process.

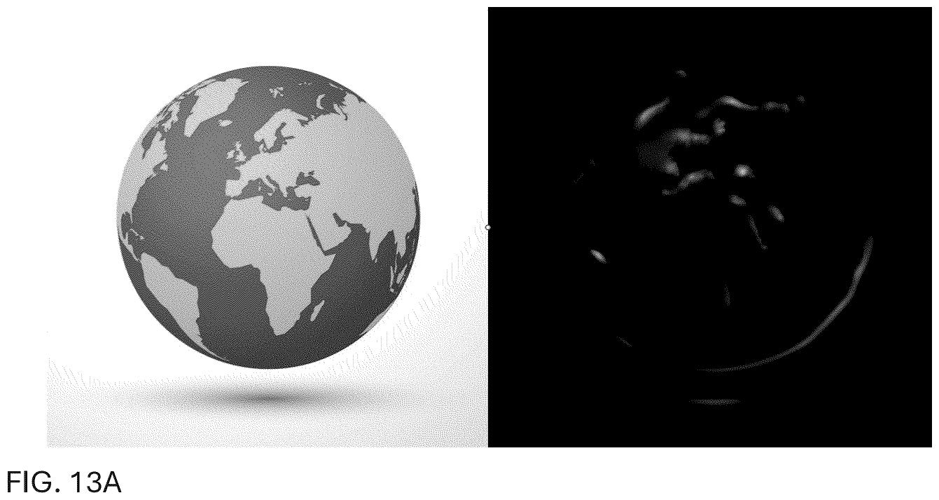

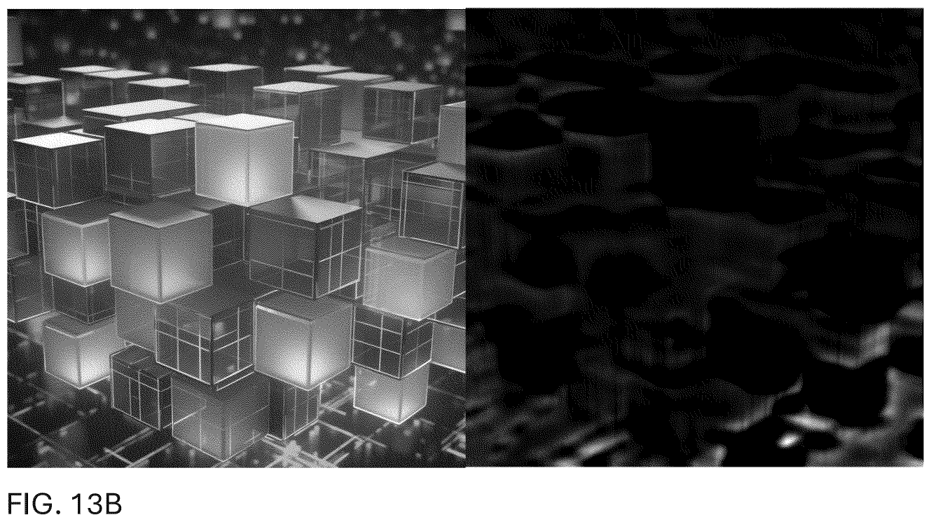

FIGS. 13A & 13B show host images (left side) vs. their corresponding visual masks (right side) generated using this Implementation 2.

In practice, in Implementation 2, we could train a CNN network based on a single image. Like Implementation 1, Implementation 2 is sensitive to the initialization of the CNN's kernels. This sensitivity is further enhanced by the fact that the network only sees one input image. Furthermore, with a single image input we potentially lose benefits of training over a distribution of images (e.g., higher potential for learning meaningful features) and we potentially lose benefits of batch normalization (e.g., better gradient flow, higher potential for arriving at a satisfactory solution).

### Implementation 3:

Implementations 1 & 2 can be viewed as optimization-based approaches specialized to a single input data point (e.g., 1 image). These implementations are sensitive to the initialization of the CNN's kernels. This sensitivity is further enhanced by the fact that the network only sees one input image. Furthermore, with a single image input we potentially lose benefits of training over a distribution of images (e.g., higher potential for learning meaningful features) and we potentially lose benefits of batch normalization (e.g., better gradient flow, higher potential for arriving at a satisfactory solution).

In contrast, Implementation 3 relies on training a CNN architecture over a distribution of images, allowing the CNN to learn more useful features with respect to visibility and/or robustness. Visibility performance can be bound by a LPIPS threshold and by one JND. Briefly, Implementation 3 proceeds as did Implementation 2 with the exception that training is over a batch of images, e.g., the COCO17 dataset. For this Implementation 3, core components of the CNN include residual blocks connected in series. Briefly, a residual block comprises convolutions of the input volume; the output of said convolutions is linearly combined with the input volume. This combination of the input volume with output features is commonly referred to as skip connections.

Algorithmically, the following steps can be implemented:

Step 1: Define the CNN architecture that takes as input a size H×W×C image and outputs a H×W array of embedding strengths on a per pixel (or group of pixels) basis. The depth of a kernel in a given layer corresponds to the number of feature maps (or channels) in the previous layer. For example, if the first layer of a CNN takes a color image as input, the kernels will typically have a depth of 3, corresponding to the RGB channels.

Step 2: Initialize weights of CNN (e.g., by pretraining). For example, initially, the values in the kernels are set randomly, and then updated through backpropagation based on a loss function of the network.

Step 3: For each image within a batch image dataset, perform steps 4-10:

Step 4: Perform a forward pass of the input batch through the CNN and obtain the visual mask.

Step 5: Embed the image using the digital watermark signal according to the visual mask.

Step 6: Measure the perceptual distance between marked and unmarked image (e.g., Mean-Squared-Error, LPIPS, other). This represents a “visibility loss.”

Step 7: Compute detection statistics with respect to the marked image. See Implementations 1 & 2, above, for examples. This represents a “detection loss.”

Step 8: Optionally, compute regularization terms (e.g., L1 (“proportional penalty”)-norm of mask, L2 (“weight decay”)-norm of mask, other). Regularization terms are techniques or modifications used to reduce the training and generalization error.

Step 9: Combine visibility, detection, and regularization losses. This yields an “overall loss.” Here again, one such loss can be weighted more heavily compared to another such loss.

Step 10: Adjust the CNN coefficients by backpropagation.

Optionally, Step 11: Repeat steps 3-10 until some convergence criteria are met or for a maximum number of permitted iterations.

### Visibility Loss:

In this Implementation 3, we strive to achieve a specific IPIPS distance target. For example, the visibility loss term takes the form (LPIPS (marked, host)—LPIPS_DISTANCE_TARGET)\hat{ }2. The target is between 0.0010-0.0750, e.g., set at: 0.0010, 0.0025, 0.0040, 0.0050, or 0.0075 (or other such values in this range). This choice is empirical as at this threshold the marked image is, in general, imperceptible with respect to the host image.

### Detection Statistics Loss:

The detection loss takes a specific form to hit a target value. That is, in contrast to previous Implementations, where the detection statistics are free to evolve during the optimization process rather than seeking to hit a target value.

### Regularization Loss:

This loss may take a form of: (alpha*norm (mask, 1)+beta*norm(mask, ‘fro’))/numel(mask). Minimization of L1-norm promotes sparsity while minimization of the Frobenious norm promotes density. Alpha and beta are coefficients with which we can exchange sparsity for density and vice versa. It is worth noting that alpha and beta were chosen empirically such that the masks are meaningful in most cases. However, it is likely that different alpha and beta duplets will result in more meaningful masks for different images.

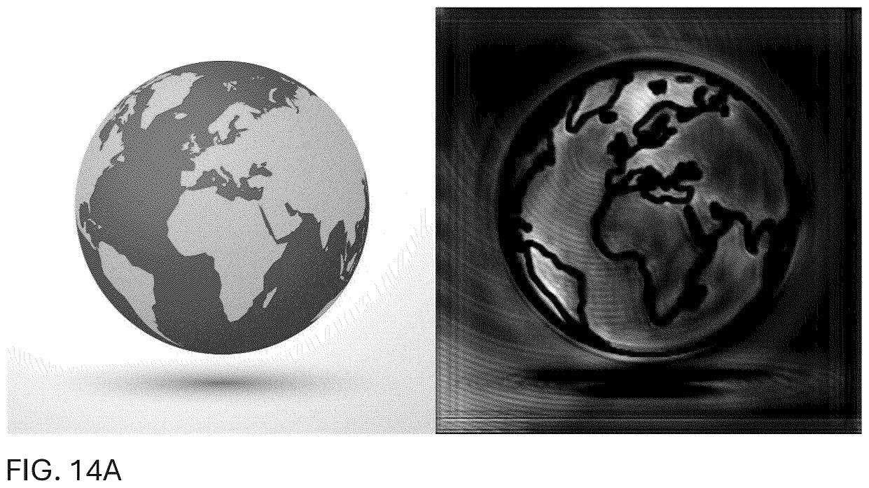

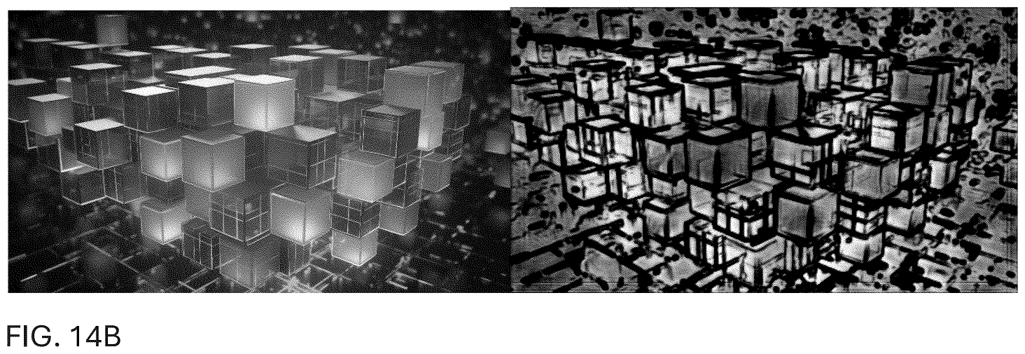

FIGS. 14A & 14B show host images (left sides) vs. their corresponding visual masks (right sides) generated using this Implementation 3. As the examples suggest, training over a distribution of images results in more visually pleasing masks.

### Implementation 4

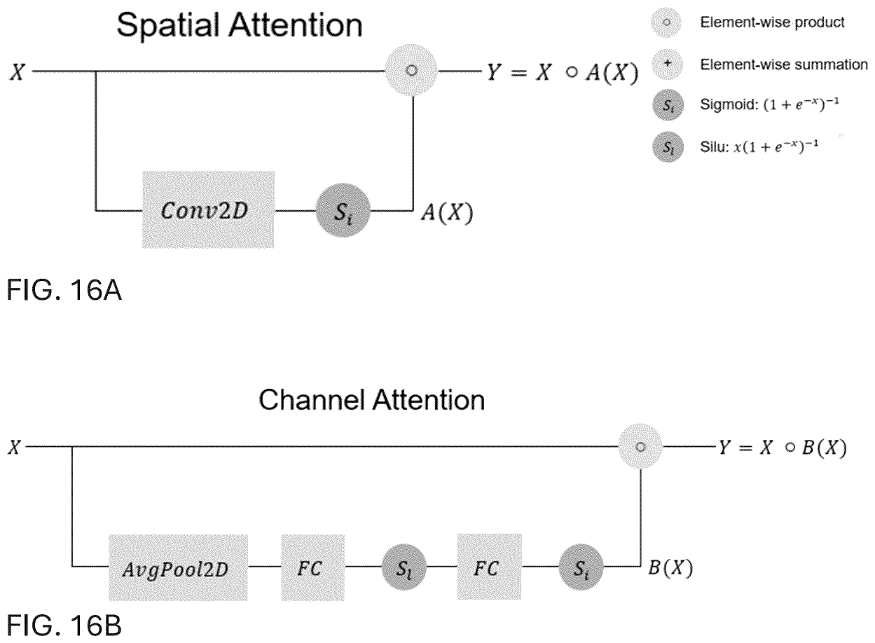

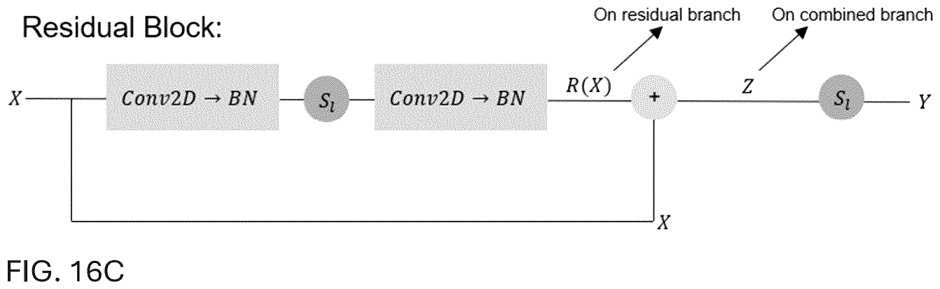

We have found further improvements of AI visual masking through modifications of a host CNN architecture. Within Implementation 3, the core components of the CNN can be constructed as residual blocks connected in series. In this Implementation 4, we add one or more convolution layers within the residual block meant to model a spatial attention mechanism. See FIG. 16A. Spatial attention in CNNs is a technique with which it is possible to focus on identifying and emphasizing relevant spatial regions within an input image, thereby enhancing the network's ability to recognize prominent features and patterns. In a sense, the change we made compared to the architecture of the CNN in Implementation 3 was to include one or more convolutional layers within the residual block such that we include a spatial attention (or pooling) mechanism. The algorithmic steps of this approach are the same as the algorithmic steps of Implementation 3.

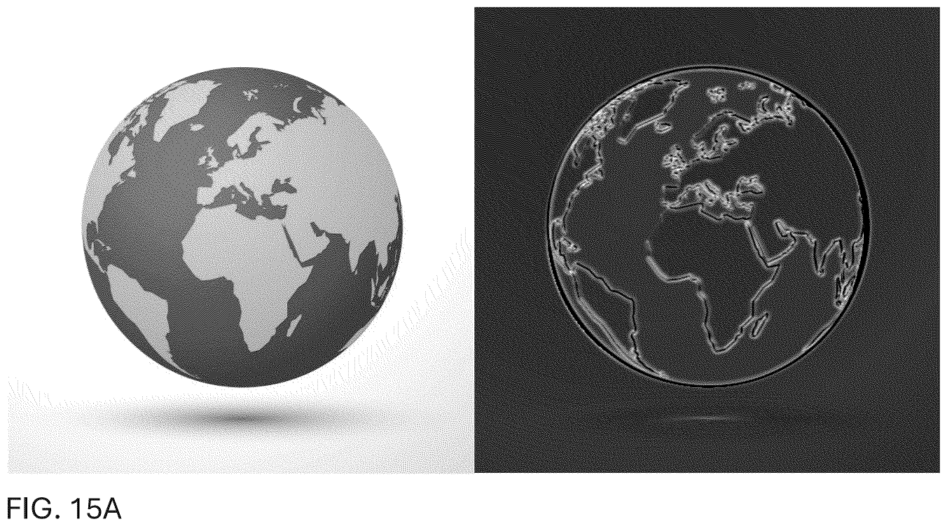

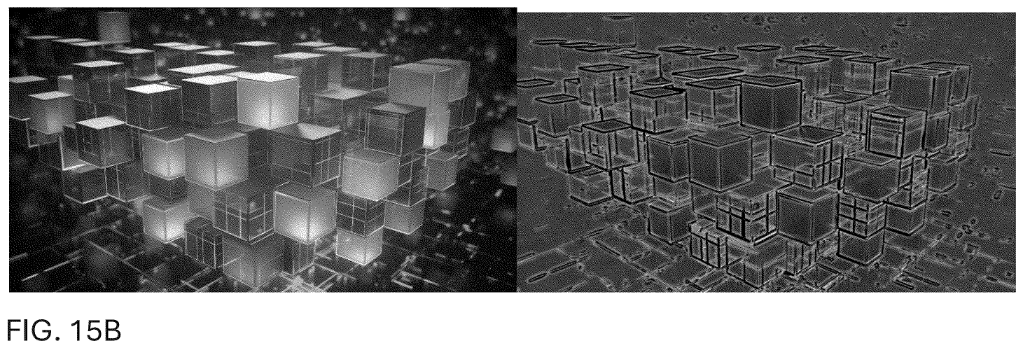

FIGS. 15A & 15B show host images (left side) vs. their corresponding visual masks (right side) generated using this Implementation 4.

### Implementation 5:

Building on the success of Implementation 4, which utilizes a spatial attention (or pooling) mechanism to enhance masking capabilities, additional attention mechanisms are used in Implementation 5. First, we extended our attention methods by utilizing the channel-wise attention mechanism. See FIG. 16B. The channel-wise attention mechanism is similar to the spatial attention method; however, instead of a convolutional layer processing spatial feature, the channel-wise attention mechanism uses an average feature pooling layer. This average feature pooling layer aggregates spatial features by extracting a single average value per channel from the input feature volume. This results in a feature vector, which is then processed by two or more fully connected (FC) layers and a sigmoid activation function to compute the importance of each feature channel in the input volume.

Additional attention mechanisms and their combinations, as well as the optimal locations for their implementation within the residual block, can be implemented. For example:

1. On residual branch:
a. Spatial attention only: Z=X+A(R(X))
b. Channel attention only: Z=X+B(R(X))
c. Both spatial and channel attention:
   i. Parallel: Z=X+A(R(X))B(R(X))
   ii. Series: Z=X+B(A(R(X)))

2. On combined branch:
a. Spatial attention only: Z=A(X+R(X))
b. Channel attention only: Z=B(X+R(X))
c. Both spatial and channel attention:
   i. Parallel: Z=A(X+R(X))B(X+R(X))
   ii. Series: Z=B(A(X+R(X)))

Based on experimentation, we found that parallel configuration of spatial and channel-wise attention mechanisms outperform others when implemented on residual branch. See FIG. 16C.

Visibility loss: Same as Implementation 3, so the target is between 0.0010-0.0750, e.g., set at: 0.0010, 0.0025, 0.0040, 0.0050, or 0.0075 (or other such values in this range).

Detection statistics loss: Same as Implementation 3.

Regularization loss: Same as Implementation 3.

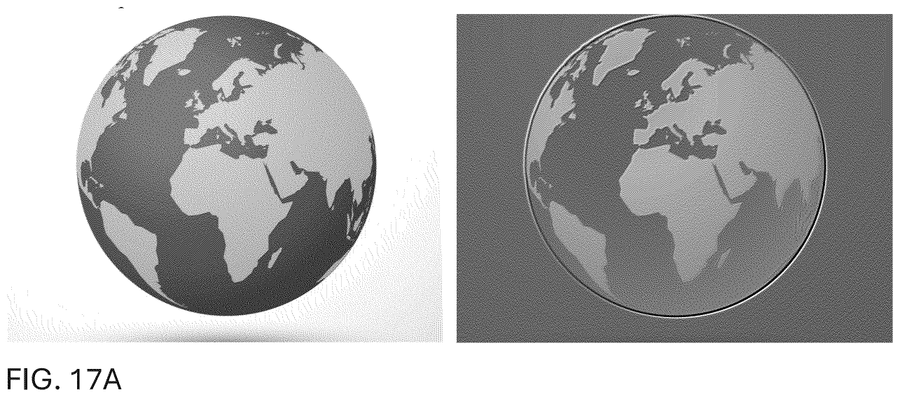

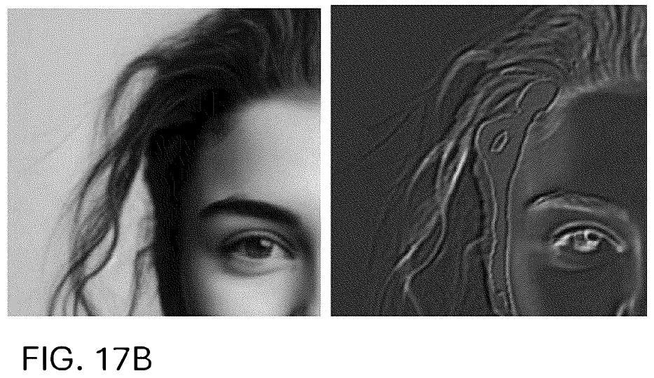

FIGS. 17A & 17B show host images (left sides) vs. their corresponding visual masks (right sides) generated using this Implementation 5.

### Implementation 6 (Inclusion of Discriminator Investigation):

As noted above, in some implementations the visibility performance of visual masking candidates can be bound by the extent to which LPIPS models the HVS and JND. In this Implementation 6, we utilize an additional mechanism to influence watermark perceptibility and mask visibility: discriminators. To elaborate, discriminators are one of two core components to generative adversarial networks (GANs), along with generators. These GAN networks use adversarial training to leverage their two components against each other. Starting from random initializations, the generator is trained to fool the discriminator with its output, while the discriminator is trained to distinguish generated and real content. In this manner, the discriminator is trained to implicitly learn distinguishing factors present in the generator's output, which in turn guides the generator to eliminate said factors. By including a discriminator network in the training process of the masking model, the discriminator will highlight distinguishing features present in watermarked images that are absent in unmarked images. In conjunction with LPIPS, this modified visibility loss enables the masking model to converge faster and reduces watermark visibility in images.

Consider the following visual mask generating algorithm:

Step 1: Define a CNN architecture that takes as input a size H-W-C image and outputs a H-W array of embedding strengths (visual masking model). Also define the CNN architecture that takes as input a size H-W-C image and outputs a classification score to distinguish between unmarked and marked images (the “discriminator”).

Step 2: Initialize weights of both masking model and discriminator CNNs (e.g., by pretraining) and begin training the models in conjunction.

Step 3: For a batch of images within an image dataset (e.g., the COCO17 dataset):

Step 4: Perform a forward pass of the input batch through the visual masking model and obtain a visual mask.

Step 5: Embed the images using a digital watermark signal according to the visual mask.

Step 6: Measure a perceptual distance between digital watermarked and unmarked (original) image (e.g., Mean-Squared-Error, LPIPS, or other perceptibility metric).

Step 7: Measure a discriminator classification loss on the marked images.

Step 8: Combine the loss calculations from Step 6 and Step 7 (keeping in mind we want to maximize the loss of Step 7, e.g., fool the discriminator with the marked images). This is referred to as a “visibility loss.”

Step 9: Compute a detection metric (see the above Implementations, above for examples) with respect to the digital watermarked image. This is referred to as a “detection loss.”

Step 10: Optionally, compute regularization terms (e.g., L1-norm of mask, L2-norm of mask, other). These are referred to as “regularization losses.”

Step 11: Combine visibility, detection, and regularization losses. As above, one such loss can be weighted more so relative to another such loss. This is referred to as the “overall loss.”

Step 12: Adjust the masking model CNN coefficients by backpropagation.

Step 13: Measure the discriminator classification loss on the marked and unmarked images.

Step 14: Adjust the discriminator CNN coefficients by backpropagation to ensure proper classification.

Optionally, Step 15: Repeat steps 3-14 until some convergence criteria are met or for a maximum number of permitted iterations.

Visibility loss: Similar to Implementation 3, the LPIPS target score is set between 0.0010-0.0750, e.g., is set at: 0.0010, 0.0025, 0.0040, 0.0050, or 0.0075 (or other such values in this range). Additionally, a discriminator loss invoking adversarial learning is included. This may take the form of a binary cross entropy loss for the discriminator (to ensure it distinguishes watermarked and unmarked images), while the masking model maximizes the discriminator loss on watermarked images (e.g., the discriminator mistakes watermarked images for unmarked images).

Regularization loss: In addition to using the discriminator to help address the visible watermark artifacts in some images, we also can use an entry-wise infinity norm of the mask (like Implementation 2).

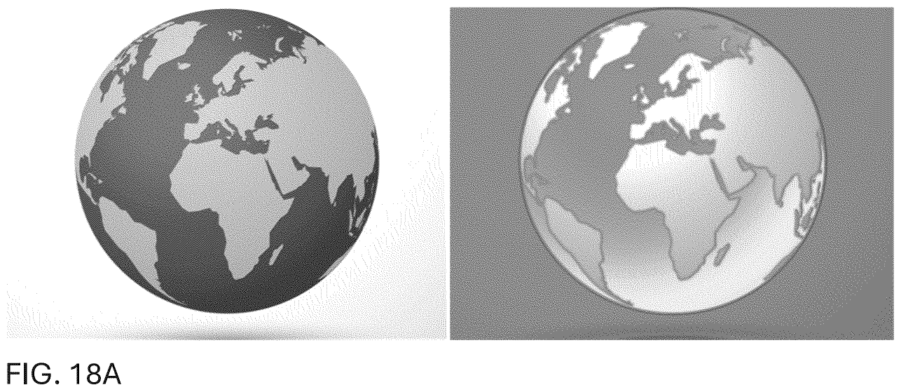

FIGS. 18A & 18B show host images (left sides) vs. their corresponding visual masks (right sides) generated using this Implementation 6.

### Embodiment 4: LPIPS Threshold Mask

As discussed above, LPIPS (Learned Perceptual Image Patch Similarity) is a distance metric that measures a distance between two images in a feature space via a pretrained CNN for classification (e.g., AlexNet, Vgg, other), which may be finetuned for the task of measuring image similarity. See again, Richard Zhang et al., “The Unreasonable Effectiveness of Deep Features as a Perceptual Metric” Proceedings-2018 IEEE/CVF Conference on Computer Vision and Pattern Recognition, CVPR 2018, IEEE Computer Society, pp 586-595, which is hereby incorporate herein by reference in its entirety. Software code corresponding to the Zhang et al. paper can be found at: https://github.com/richzhang/PerceptualSimilarity

A LPIPS threshold visual mask can be generated as follows:

Step 1: Embed a digital image with several different candidate digital watermark embedding strengths.

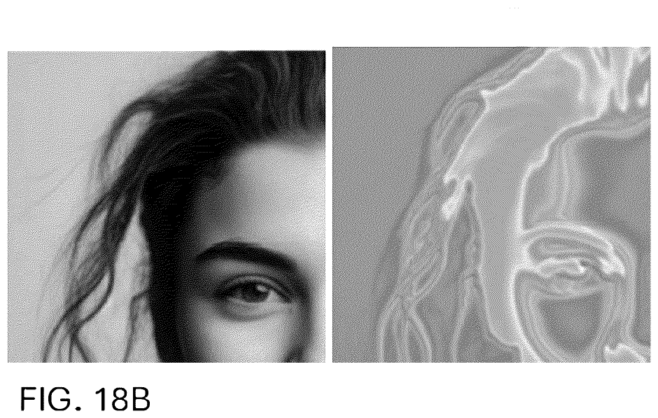

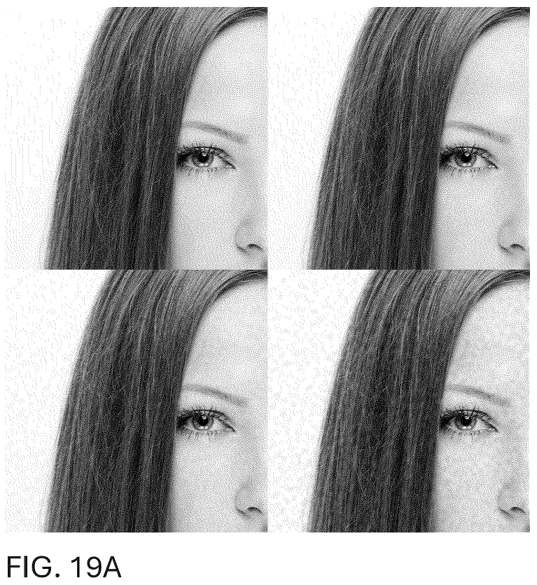

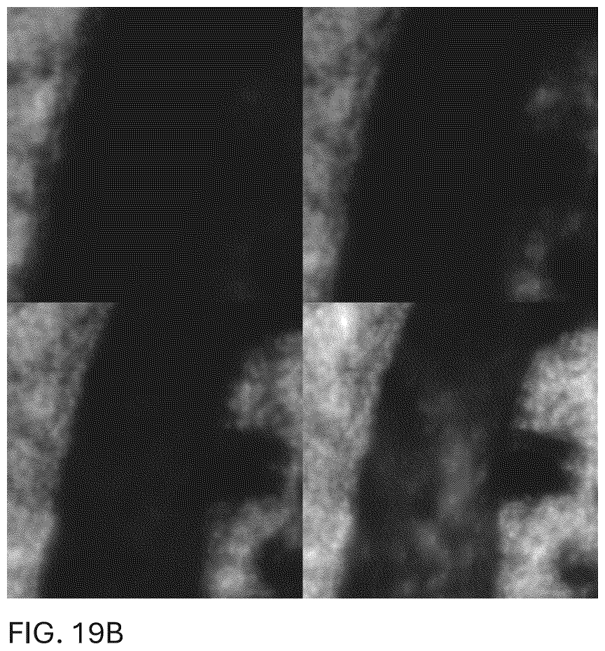

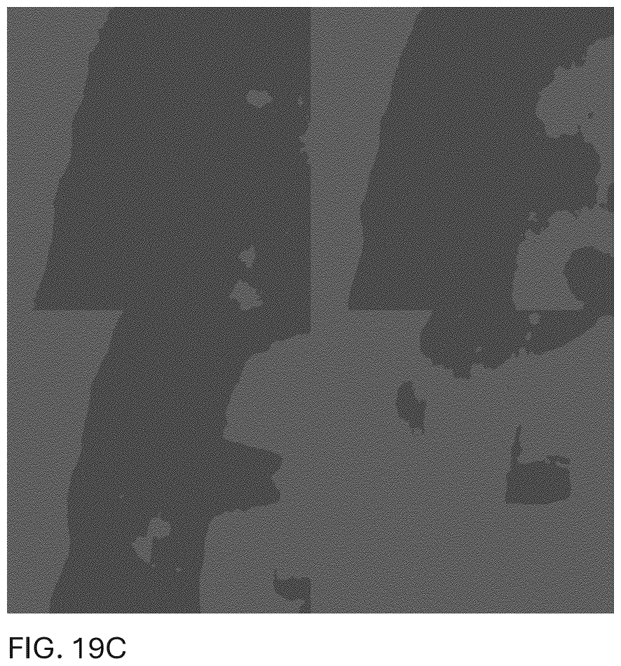

Step 2: Calculate the spatial LPIPS distance from the original image for each of these embed different candidate digital watermark embedding strengths. (“spatial LPIPS”=a distance metric from the original image computed at each point). FIG. 19A shows 4 different embedding strengths from top left (2), top right (4), bottom left (8) and bottom right (16). A 2 embedding strength is weaker compared to the 4, 8 and 16 strengths. As a result, the digital watermark signal is more visible in the bottom right (16) image compared to the top left (and other 2 images as well). FIG. 19B includes four LPIPS maps corresponding to the embedded images in FIG. 19A. The LPIPS maps show IPIPS spatial distance from the original image to each embedded image for each of strengths 2, 4, 8, 16. In the LPIPS images, white is more visible, and black is less visible.

Step 3: At each pixel of the image, find the highest embed strength that is less than a set LPIPS threshold target. This determines a mask for the image.

FIG. 19C has four image maps corresponding to FIGS. 19A & 19B with color showing areas that violate a LPIPS threshold (e.g., here set to 0.04). Red indicates more visible (or change from the original) than allowed by the threshold, so a lower embedding strength is needed.

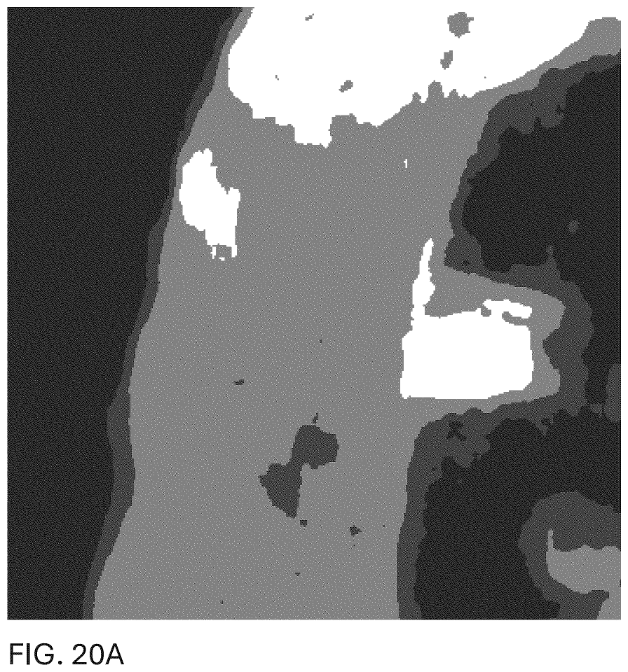

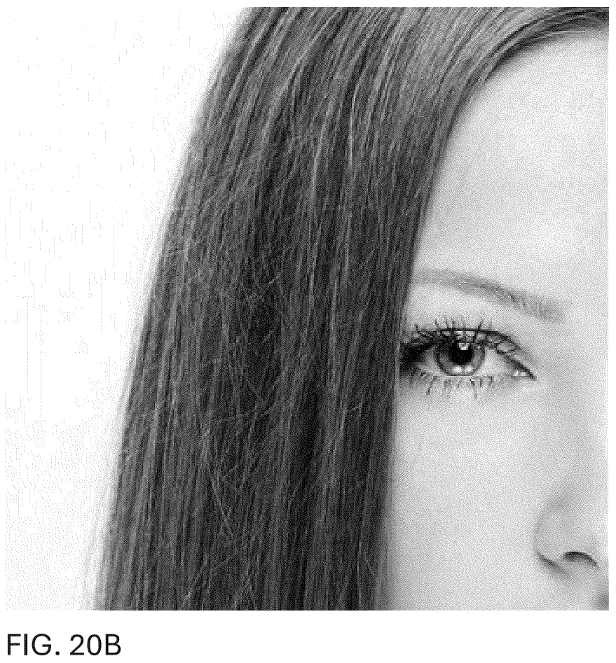

FIG. 20A shows a coarse LPIPS threshold visual mask from the original (unembedded) image built from digital watermark embedding strengths 2, 4, 8, and 16, where white=16, black=2, and grey is in between. FIG. 20B shows an image embedded using the FIG. 20A mask.

In a variation of this embodiment, the above LPIPS visual mask generation algorithm can be augmented as follows:
Augmentation 1: Select a differentiable model for the mask (e.g., a 2-D sum of B-splines or a network-based model); and/or
Augmentation 2: Use gradient info provided from LPIPS threshold visual mask to iteratively minimize the distance from the LPIPS threshold while remaining below it elsewhere.

Now let's add even more details. One objective of building a LPIPS threshold visual mask is to digital watermark an image that will roughly satisfy the LPIPS threshold over a majority of the image by treating LPIPS like a pixel-independent distance metric. (Of course, LPIPS is not really pixel independent, but this assumption works reasonably well depending on the image content and expected viewing scale. It's also possible to improve how well this assumption works through LPIPS parameter choices—for example, using the VGG network rather than the default AlexNet network for LPIPS is observed to provide improved results, presumably because the VGG resamples images to a higher resolution 512×512 size rather than 256×256, which preserves more local detail.)

There is nothing LPIPS-specific to the visual mask generation steps above that prevents other image distance metrics from being used. The main objectives would be: 1. The distance metric has to be computed at each pixel (or pixel group 2×2, 3×3). 2. The distance metric has features that correlate well with JND approximation, e.g., they tend to cluster images that are perceptually similar at similar values, so a threshold can be set (e.g., a threshold of 1=too visible is roughly true for any image used). 3. The more the distance metric can be computed independently on a per-pixel basis, the better, since as mentioned above, the algorithm treats this as if it's true.

Other metrics (besides LPIPS) with the above properties could be used and could hypothetically work better. For example, Peak Signal-to-Noise Ratio (PSNR), Structural Similarity Index (SSIM), Multi-Scale Structural Similarity Index (MS-SSIM), Visual Information Fidelity (VIF), and/or Feature Similarity Index (FSIM) could be used to create a visual mask.

LPIPS uses image features from existing image classification neural network models to build a distance metric that fits data for various types of image distortions. A similar model tuned to fit data specifically for a particular digital watermark scheme would be expected to work somewhat better.

The LPIPS distance metric is not tuned to an absolute JND (just-noticeable-difference), so some calibration is required. A way to do this is to assess JND embed strengths on several images, calculate the LPIPS distance from these, and determine the threshold from that data. Example Combinations of Features

Without limiting the scope of the appended claims, the following combinations of features are provided as non-limiting examples that demonstrate specific arrangements and aspects of the present disclosure. Of course, other combinations will be readily apparent from the written description and drawings.

A1. A method of generating a visual mask using one or more Convolutional Neural Networks (CNN), the visual mask to guide digital watermark embedding of digital imagery, said method comprising: initializing weights of a visual masking CNN and a discriminator CNN, in which the visual masking CNN generates the visual mask and the discriminator CNN discriminates between an input image and an embedded input image, the embedded input image comprising a digital watermark embedded therein, said initializing yielding initialized weights of the visual masking CNN and initialized weights of the discriminator CNN; for each input image within a batch of input images: executing a forward pass of the input image through the visual masking CNN to obtain a visual mask; embedding the input image with a digital watermark signal according to the visual mask to yield an embedded input image; determining a perceptual distance metric between the input image and the embedded input image; determining a discriminator classification loss for the embedded input image; combining the perceptual distance metric and the discriminator classification loss to yield a visibility loss; determining a detection metric associated with detection of the digital watermark signal from the embedded input image; and combining visibility loss and the detection metric to yield an overall loss; adjusting the initialized weights of the visual masking CNN by back-propagation to minimize the overall loss; and adjusting the initialized weights of the discriminator CNN by back-propagation to minimize discriminator classification loss on marked and unmarked images.

A2. The method of A1 further comprising: repeating acts of the method until a predetermined convergence criteria is met or repeated for a predetermined maximum number of iterations.

B1. A method of generating a visual mask to guide digital watermark signal embedding within digital imagery, said method comprising: obtaining a digital image; first embedding the digital image with a digital watermark signal using a first digital watermark embedding strength, said first embedding yielding a first embedded digital image; second embedding the digital image with a digital watermark signal using a second digital watermark embedding strength that is different than the first digital watermark embedding strength, said second embedding yielding a second embedded digital image; third embedding the digital image with a digital watermark signal using a third digital watermark embedding strength that is different than the first digital watermark embedding strength and different than the second digital watermark embedding strength, said third embedding yielding a third embedded digital image; generating a spatial LPIPS distance from the digital image for each of the first embedded digital image, second embedded digital image and third embedded digital image, said generating yield a first LPIPS map, a second LPIPS map and a third LPIPS map; and for each pixel location or group of pixel locations of the digital image, determining from the first LPIPS map, the second LPIPS map and the third LPIPS map, a highest embedding strength that is less than a predetermined LPIPS threshold; and creating the visual mask using a determined embedding strength for each pixel location or group of pixel locations.

B2. The method of claim B1 in which the predetermined LPIPS threshold is between 0.0010 and 0.0750.

B3. The method of claim B1 in which the predetermined LPIPS threshold is set at one of: 0.0010, 0.0025, 0.0040, 0.0050, or 0.0075.

B4. The method of claim B1 further comprising fourth embedding the digital image with a digital watermark signal using a fourth digital watermark embedding strength that is different than the first digital watermark embedding strength, different than the second digital watermark embedding strength, and different than the third digital watermark embedding strength, said fourth embedding yielding a fourth embedded digital image.

B5. The method of B4 further comprising generating a fourth LPIPS map for the fourth embedded digital image.

B6. The method of B1 in which the first digital watermark embedding strength is 2, the second digital watermark embedding strength is 4, the third digital watermark embedding strength is 8, and the fourth digital watermark embedding strength is 16.

B7. The method of B1 further comprising embedding the digital image with the digital watermark signal according to the visual mask.

B8. The method of B1 in which the spatial LPIPS distance is determined using a VGG network.

B9. The method of B1 in which the spatial LPIPS distance is determined using an AlexNet network.

B10. The method of B1 further comprising: selecting a differentiable model for the visual mask; and using gradient information provided from the visual mask to iteratively minimize the distance from the predetermined LPIPS threshold while remaining below the predetermined LPIPS threshold elsewhere.

B11. The method of B10 in which the differentiable model comprises a 2-D sum of B-splines.

B12. The method of B10 in which the differentiable model comprises a network-based model.

C1. A system for generating a visual mask to guide digital watermark embedding of digital imagery, said system comprising: means for generating a pattern mask representing image variation within digital imagery; means for generating a contrast mask representing contrast within the digital imagery; means for generating a standard deviation (SD) map of the digital imagery, in which values within the SD map represent a standard deviation of a pixel value or group of pixels values relative to a local neighborhood of pixels, and in which the SD map comprises a plurality of texture bands; means for altering the contrast mask according to the plurality of texture bands, said altering yielding an altered contrast mask; and means for combining the pattern mask and the altered contrast mask and using such resulting combination to adjust a digital watermark signal strength.

C2. The system of C1 in which the image variation comprises luminance contrast and pattern complexity.

D1. A system for generating a visual mask to guide digital watermark embedding of digital imagery, said system comprising: means for obtaining an original image comprising Red, Green and Blue color channels; means for converting the original image into a luminance image; means for transforming the luminance image using a Dual-Tree Wavelet Transform (DTCWT), the DTCWT comprising complex DTCWT coefficients; means for calculating an absolute value of each of the complex DTCWT coefficients to yield refined DTCWT coefficients; means for filtering the refined DTCWT coefficients to reduce outliers; and means for predicting a visual mask as a function of filtered DTCWT coefficients, said predicting yielding a predicted visual mask.

D2. The system of D1 in which the function comprises a linear function.

D3. The system of D1 further comprising means for upsampling the predicted visual mask to an original image resolution.

E1. A system for generating a visual mask to guide digital watermark embedding of digital imagery, said system comprising: means for initializing values within the visual mask, the values corresponding to pixel locations of a digital image; means for embedding the digital image with a digital watermark signal according to the values within the visual mask, said embedding yielding an embedded digital image; means for determining a perceptual distance between the digital image and the embedded digital image; means for determining a detection measure with respect to the embedded digital image; means for combining the perceptual distance and the detection measure to yield a combined metric; and means for adjusting the values within the visual mask to minimize an overall loss of a neural network.

E2. The system of E1, further comprising means for repeating operations until a predetermined convergence criteria is met or repeated for a predetermined maximum number of iterations.

E3. The system of E1 in which said means for adjusting comprises means for computing a partial derivative of the overall loss with respect to each value within the visual mask; and means for computing a gradient to inform how each value within the visual mask is to be adjusted.

F1. A system for generating a visual mask using a Convolutional Neural Network (CNN), the visual mask to guide digital watermark embedding of digital imagery, said system comprising: means for initializing weights of the CNN; means for performing a forward pass of an input image through the CNN to obtain a visual mask, the visual mask intended to guide digital watermarking of the input image, the visual mask comprising a plurality of values, each of which corresponds to a pixel location or group of pixels location; means for embedding the input image using a digital watermark signal according to the visual mask, said embedding yielding an embedded input image; means for determining a perceptual metric between the input image and the embedded input image; means for determining a detection metric associated with detection of the digital watermark signal from the embedded input image; means for combining the perceptual metric and the detection metric to yield an overall loss; and means for adjusting the weights of the CNN by backpropagation to reduce the overall loss.

F2. The system of F1 further comprising means for determining regularization terms, in which the overall loss represents the regularization terms.

G1. A system for generating a visual mask using one or more Convolutional Neural Networks (CNN), the visual mask to guide digital watermark embedding of digital imagery, said system comprising: means for initializing weights of a visual masking CNN and a discriminator CNN, in which the visual masking CNN generates the visual mask and the discriminator CNN discriminates between an input image and an embedded input image, the embedded input image comprising a digital watermark embedded therein; means for executing a forward pass of an input image through the visual masking CNN to obtain a visual mask; means for embedding the input image with a digital watermark signal according to the visual mask to yield an embedded input image; means for determining a perceptual distance metric between the input image and the embedded input image; means for determining a discriminator classification loss for the embedded input image; means for combining the perceptual distance metric and the discriminator classification loss to yield a visibility loss; means for determining a detection metric associated with detection of the digital watermark signal from the embedded input image; means for combining visibility loss and the detection metric to yield an overall loss; means for adjusting the visual masking CNN weights by back-propagation; and means for adjusting the discriminator CNN weights by back-propagation to maximize false negative classification of embedded input images.

H1. A system for generating a visual mask to guide digital watermark signal embedding within digital imagery, said system comprising: means for obtaining a digital image; means for first embedding the digital image with a digital watermark signal using a first digital watermark embedding strength, said first embedding yielding a first embedded digital image; means for second embedding the digital image with a digital watermark signal using a second digital watermark embedding strength that is different than the first digital watermark embedding strength, said second embedding yielding a second embedded digital image; means for third embedding the digital image with a digital watermark signal using a third digital watermark embedding strength that is different than the first digital watermark embedding strength and different than the second digital watermark embedding strength, said third embedding yielding a third embedded digital image; means for generating a spatial LPIPS distance from the digital image for each of the first embedded digital image, second embedded digital image and third embedded digital image, said generating yield a first LPIPS map, second LPIPS map and a third LPIPS map; means for determining, for each pixel location or group of pixel locations of the digital image, from the first LPIPS map, the second LPIPS map and the third LPIPS map, a highest embedding strength that is less than a predetermined LPIPS threshold; and means for creating the visual mask using a determined embedding strength for each pixel location or group of pixel locations.

H2. The system of H1 in which the predetermined LPIPS threshold is between 0.0010 and 0.0750.

H3. The system of H1 in which the predetermined LPIPS threshold is set at one of: 0.0010, 0.0025, 0.0040, 0.0050, or 0.0075.

H4. The system of H1 further comprising: means for fourth embedding the digital image with a digital watermark signal using a fourth digital watermark embedding strength that is different than the first digital watermark embedding strength, different than the second digital watermark embedding strength, and different than the third digital watermark embedding strength, said fourth embedding yielding a fourth embedded digital image; and means for generating a fourth LPIPS map for the fourth embedded digital image.

I1. A method of generating a visual mask to guide digital watermark embedding of digital imagery, said method comprising: obtaining an original image comprising Red, Green and Blue color channels; converting the original image into a luminance image; transforming the luminance image using a Dual-Tree Wavelet Transform (DTCWT), the DTCWT comprising complex DTCWT coefficients; calculating an absolute value of each of the complex DTCWT coefficients to yield refined DTCWT coefficients; filtering the refined DTCWT coefficients to reduce outliers; and predicting a visual mask as a function of filtered DTCWT coefficients, said predicting yielding a predicted visual mask.

I2. The method of I1 in which the function comprises a linear function.

I3. The method of I1 further comprising upsampling the predicted visual mask to an original image resolution.

I4. A non-transitory computer-readable medium comprising an upsampled, predicted visual mask stored thereon, the upsampled, predicted visual mask having been generated by the method of I3.

J1. A method of generating a visual mask to guide digital watermark embedding of digital imagery, said method comprising: generating a pattern mask representing image variation within digital imagery; generating a contrast mask representing contrast within the digital imagery; generating a standard deviation (SD) map of the digital imagery, in which values within the SD map represent a standard deviation of a pixel value or group of pixels values relative to a local neighborhood of pixels, and in which the SD map comprises a plurality of texture bands; altering the contrast mask according to the plurality of texture bands, said altering yielding an altered contrast mask; and combining the pattern mask and the altered contrast mask and using such resulting combination to adjust a digital watermark signal strength.

J2. The method of J1 in which the image variation comprises luminance contrast and pattern complexity.

J3. A non-transitory computer-readable medium comprising a visual mask stored thereon, the visual mask having been generated by the method of J2.

### CONCLUDING REMARKS

The technology, modules, functionality, methods, processes, and systems described above may be implemented in hardware, software, or a combination of hardware and software. For example, the verification system and/or the digital asset validation system described above may be implemented as instructions stored in a memory and executed in one or more processors (including both software and firmware instructions), implemented as digital logic circuitry in a special purpose digital circuit, or combination of instructions executed in one or more multi-core processors, one or more parallel processors and/or one or more digital logic circuit modules. For example, the various visual mask generating systems described above may be implemented as instructions stored in a memory and executed in one or more multi-core processors (including both software and firmware instructions), implemented in an Artificial Intelligence (AI) chip (e.g., an AI accelerator, or a plurality of Tensor cores provided by NVIDIA), implemented as digital logic circuitry in a special purpose digital circuit, or combination of instructions executed in one or more multi-core processors, AI-chip, one or more parallel processors and/or one or more digital logic circuit modules. The technology, modules, methods, services, functionality, and processes described above may be implemented in software programs executed from a system's memory (a non-transitory computer readable medium such as an electronic, solid-state, optical and/or magnetic storage memory). When the software is executed, its software instructions cause one or more processors, one or more multi-core processors, one or more parallel processors to execute or carry out the various acts or functionality scripted therein. The methods, instructions and circuitry operate on electronic signals, or signals in other electromagnetic forms. These signals further represent physical signals like image signals captured in image sensors, audio captured in audio sensors, as well as other physical signal types captured in sensors for that type. These electromagnetic signal representations are transformed into different states as detailed above to detect signal attributes, perform pattern recognition and matching, determine relative attributes of Scans, etc.

The various visual mask generation systems described above may be implemented using specialized hardware, software executed on general-purpose computing devices, or combinations thereof. For example, means for generating pattern masks, contrast masks, SD maps, and other visual mask components may be implemented as software modules executed by one or more processors, one or more multicore processors, one or more parallel processors, one or more GPUs, as dedicated hardware circuits, or as combinations of hardware and software.

For the PMC approach described in Embodiment 1, means for generating a pattern mask may include, e.g., image processing circuitry or software modules configured to analyze image variation, including luminance contrast and pattern complexity. Means for generating a contrast mask may include, e.g., contrast analysis circuitry or software modules implementing contrast detection algorithms such as Laplacian filters, Sobel operators, or the Wu methodology described above. Means for generating a standard deviation map may include, e.g., statistical analysis circuitry or software modules configured to calculate pixel value deviations within defined neighborhoods. Means for altering a contrast mask according to texture bands may include, e.g., adaptive processing circuitry or software modules that apply different scaling factors based on texture classification. Means for combining the pattern mask and altered contrast mask may include, e.g., signal processing circuitry or software modules that perform weighted combinations of the masks to produce the final visual mask.

For the wavelet-based approach described in Embodiment 2, means for obtaining an original image may include, e.g., image acquisition circuitry or software modules for loading image data. Means for converting the original image into a luminance image may include, e.g., color space conversion circuitry or software modules implementing colorimetric transformations. Means for transforming the luminance image using DTCWT may include, e.g., signal processing circuitry or software modules implementing the dual-tree complex wavelet transform algorithms. Means for calculating absolute values of complex DTCWT coefficients may include, e.g., mathematical processing circuitry or software modules. Means for filtering the refined DTCWT coefficients may include, e.g., digital filtering circuitry or software modules implementing median filters or other outlier reduction techniques. Means for predicting a visual mask may include, e.g., prediction circuitry or software modules implementing linear or non-linear functions of the filtered coefficients. Means for upsampling may include, e.g., interpolation circuitry or software modules that restore the mask to original image resolution.

For the AI-based approaches described in Embodiment 3, means for initializing values or weights may include, e.g., memory circuitry or software modules for parameter initialization. Means for embedding digital images with watermark signals may include, e.g., watermark embedding circuitry or software modules implementing the embedding algorithms described, e.g., in Section I. Means for determining perceptual distances or metrics may include, e.g., perceptual analysis circuitry or software modules implementing MSE, LPIPS, or other perceptual metrics. Means for determining detection measures or metrics may include, e.g., detection analysis circuitry or software modules implementing the detection statistics described above. Means for combining metrics to yield overall losses may include, e.g., mathematical processing circuitry or software modules implementing weighted combinations. Means for adjusting values or weights may include, e.g., optimization circuitry or software modules implementing backpropagation or other gradient-based optimization techniques.

For the LPIPS Threshold Mask approach described in Embodiment 4, the means for obtaining a digital image may include, e.g., image acquisition circuitry or software modules. Means for embedding with different strengths may include, e.g., watermark embedding circuitry or software modules capable of applying variable embedding strengths. Means for generating spatial LPIPS distances may include, e.g., perceptual analysis circuitry or software modules implementing the LPIPS algorithm. Means for determining highest embedding strengths below thresholds may include, e.g., comparison circuitry or software modules implementing threshold-based selection. Means for creating the visual mask may include, e.g., mask generation circuitry or software modules that compile the selected embedding strengths into a cohesive mask.

The visual mask generation systems may also include, e.g., means for selecting differentiable models for masks and means for using gradient information to iteratively optimize masks, which may be implemented as model selection circuitry or software modules and gradient processing circuitry or software modules, respectively.

These various means also may be implemented using general-purpose processors executing software instructions, application-specific integrated circuits (ASICs), field-programmable gate arrays (FPGAs), digital signal processors (DSPs), graphic processor units (GPUs), multicore processors, or combinations thereof. The specific hardware or software implementation may vary depending on factors such as required processing speed, power consumption constraints, and integration with other systems.

Having described and illustrated the principles of the technology with reference to specific implementations, it will be recognized that the technology can be implemented in many other, different, forms. To provide a comprehensive disclosure without unduly lengthening the specification, applicants incorporate by reference—in their entirety—the patents and patent applications referenced above, including all drawings, and any appendices.

The particular combinations of elements and features in the above-detailed embodiments are exemplary; the interchanging and substitution of these teachings with other teachings in this and the incorporated-by-reference patents/applications are also contemplated. Any headings used in this document are for the reader's convenience and are not intended to limit the disclosure. We expressly contemplate combining the subject matter under the various headings.

1. A method of generating a visual mask to guide digital watermark embedding of digital imagery using a neural network, said method comprising:
initializing values within the visual mask, the values corresponding to pixel locations of a digital image;
embedding the digital image with a digital watermark signal according to the values within the visual mask, said embedding yielding an embedded digital image;
determining a perceptual distance between the digital image and the embedded digital image;
determining a detection measure with respect to the embedded digital image;
combining the perceptual distance and the detection measure to yield a combined metric; and
adjusting the values within the visual mask to minimize an overall loss of the neural network.

2. The method of claim 1, further comprising repeating acts of the method until a predetermined convergence criteria is met or repeated for a predetermined maximum number of iterations.

3. The method of claim 1 in which said adjusting comprises computing a partial derivative of the overall loss with respect to each value within the visual mask; and computing a gradient to informs how each value within the visual mask is to be adjusted.

4. The method of claim 1 in which the perceptual distance is determined by utilizing a Mean-Squared-Error or LPIPS function.

5. The method of claim 1 in which said combining comprises a linear combination, or a weighted version of such.

6. A method of generating a visual mask using a Convolutional Neural Network (CNN), the visual mask to guide digital watermark embedding of digital imagery, said method comprising:
initializing weights of the CNN to yield initialized weights;
performing a forward pass of an input image through the CNN to obtain a visual mask, the visual mask intended to guide digital watermarking of the input image, the visual mask comprising a plurality of values, each of which corresponds to a pixel location or group of pixels location;
embedding the input image using a digital watermark signal according to the visual mask, said embedding yielding an embedded input image;
determining a perceptual metric between the input image and the embedded input image;
determining a detection metric associated with detection of the digital watermark signal from the embedded input image;
combining the perceptual metric and the detection metric to yield an overall loss; and
adjusting the initialized weights of the CNN by backpropagation to reduce the overall loss.

7. The method of claim 6, further comprising repeating acts of the method until a predetermined convergence criteria is met or repeated for a predetermined maximum number of iterations.

8. The method of claim 6 in which said adjusting comprises computing a partial derivative of the overall loss with respect to each value within the visual mask; and computing a gradient to informs how each value within the visual mask is to be adjusted.

9. The method of claim 6 in which the perceptual metric is determined by utilizing a Mean-Squared-Error or LPIPS function.

10. The method of claim 6 in which said combining comprises a linear combination, or a weighted version of such.

11. The method of claim 6 in which said initializing weights of the CNN comprises randomly selecting values for CNN kernels, which are updated via said adjusting.

12. The method of claim 6 further comprising determining regularization terms, in which the overall loss represents the regularization terms.

13. A method of generating a visual mask using a Convolutional Neural Network (CNN), the visual mask to guide digital watermark embedding of digital imagery, said method comprising:
initializing weights of the CNN;
for each input image within a batch of input images:
executing a forward pass of an input image through the CNN to obtain the visual mask;
embedding the input image using a digital watermark signal according to the visual mask to yield an embedded input image;
determining a perceptual difference metric between the input image and the embedded input image;
determining a detection metric associated with detecting the digital watermark signal from the embedded input image;
combining the perceptual difference metric and the detection metric to yield an overall loss; and
adjusting the weights of the CNN to minimize the overall loss.

14. The method of claim 13, further comprising repeating acts of the method until a predetermined convergence criteria is met or repeated for a predetermined maximum number of iterations.

15. The method of claim 13 in which said adjusting comprises computing a partial derivative of the overall loss with respect to each value within the visual mask; and computing a gradient to informs how each value within the visual mask is to be adjusted.

16. The method of claim 13 in which the perceptual difference metric is determined by utilizing a Mean-Squared-Error or LPIPS function.

17. The method of claim 13 in which said combining comprises a linear combination, or a weighted version of such.

18. The method of claim 13 in which said initializing weights of the CNN comprises randomly selecting values for CNN kernels, which are updated via said adjusting using backpropagation.

19. The method of claim 13 further comprising determining regularization terms, in which the overall loss represents the regularization terms.

20. A non-transitory computer readable medium comprising instructions stored therein that, when executed by one or more multi-core processors, cause said one or more multi-core processors to perform the method of claim 13.
